(19) United States
(12) Patent Application Publication
(10) Pub. No.: US 2026/0079667 A1
(43) Pub. Date: Mar. 19, 2026

(54) Distributing Processing Loads Across Audio Devices

(71) Applicant: Shure Acquisition Holdings, Inc., Niles, IL (US)

(72) Inventors: Bijal Joshi, Schaumburg, IL (US); Matthew R. Kirsch, Evanston, IL (US); Guillaume Lamy, Chicago, IL (US)

(21) Appl. No.: 19/025,173

(22) Filed: Jan. 16, 2025

Related U.S. Application Data
(60) Provisional application No. 63/694,477, filed on Sep. 13, 2024.

(51) Int. Cl. G06F 3/16

(52) U.S. Cl. CPC G06F 3/162

(57) ABSTRACT

Digital signal processing (DSP) may be distributed across a plurality of endpoints and one or more aggregators in an audio system. One or more aggregators may perform selected DSP features and/or may control selected DSP features for performance by one or more endpoints, by load-balancing the DSP features across the endpoint(s) and/or the aggregator(s). Links may be established between the aggregator(s) and the endpoint(s) to communicate audio signals and related information for performing the DSP features.

### CROSS-REFERENCE TO RELATED APPLICATIONS

The present application claims priority to U.S. Provisional Patent Application Ser. No. 63/694,477, entitled “Networked Audio-Related Digital Signal Processing,” filed Sep. 13, 2024, hereby incorporated by reference in its entirety.

### TECHNICAL FIELD

Aspects of the disclosure relate to electronic audio communications and more specifically to distributed audio digital signal processing across multiple networked audio devices.

### BACKGROUND

Digital signal processing (DSP) is used to improve audio signals. In an audio system, a centralized processor performs DSP on audio signals received from audio devices such as microphones. Audio received by each microphone is communicated to the centralized processor. DSP by the centralized processor is subject to limitations of the centralized processor, such as processing speed, bandwidth, capacity, temperature constraints, and the like.

### SUMMARY

The following presents a simplified summary of the disclosure in order to provide a basic understanding of some aspects of the disclosure. This summary is not an extensive overview of the disclosure. It is not intended to identify key or critical elements of the invention or to delineate the scope of the invention. The following summary merely presents some concepts of the disclosure in a simplified form as a prelude to the more detailed description provided below.

An audio system is described herein that may comprise one or more aggregators and a plurality of endpoints for communicating and/or processing audio signals and related information. Endpoints may comprise any device capable of receiving, sending, and/or processing audio and related information, such as a microphone, speaker, video camera, sensor, and the like. One or more of the endpoints may be configured to operate as an aggregator, such that an aggregator may be capable of receiving, sending, and/or processing audio and related information. An aggregator may control DSP performed by one or more of the endpoints in a distributed (e.g., networked) manner. For example, rather than a single device or other component such as a centralized processor performing all DSP features for an audio system, DSP in the audio system described herein may be distributed across a plurality of devices/components. Load-balancing may be used to determine the distribution of DSP features across the devices/components of the audio system. DSP features for endpoints may be enabled/disabled and/or activated/deactivated under control of an aggregator to facilitate efficient use of DSP capabilities across the audio system. The DSP features performed by endpoints may be in addition to or in place of at least some DSP features performed by an aggregator, for example, based on various system requirements, capabilities, bandwidth, available processing resources, memory, physical and/or logical device location, DSP feature priorities, and/or other conditions. Different DSP features may be performed by different audio devices in a networked manner that may optimize DSP across the audio system.

The audio system described herein may provide a variety of advantages over other audio systems. For example, by load-balancing DSP features across devices, the audio system described herein may avoid overloading any single device, such as an aggregator, by not overusing DSP capabilities (e.g., processing, bandwidth, memory, capacity, etc.) of that device and by instead sharing DSP across a plurality of devices (e.g., one or more endpoints and/or one or more aggregators). Additionally or alternatively, by load-balancing DSP features across multiple devices, groups of devices may be configured to perform certain DSP features in a complementary and networked manner, for example, based on endpoint locations and/or capabilities, and/or to perform or achieve load-balancing of the DSP features across the processing resources of multiple endpoints and/or other devices in the audio system. The audio system described herein may be flexible to accommodate a variety of configurations that may allow for ease of scalability, such as by accommodating the addition of endpoints without a corresponding need for additional aggregators to perform DSP. The audio system described herein may provide improved efficiency, for example, by enabling devices that may be better equipped, located, and/or capable of performing certain DSP to perform those DSP features. The audio system described herein may provide improved robustness and/or flexibility, for example, by not relying upon a single device for all DSP of the audio system. The audio system described herein may provide enhanced performance for DSP and/or other operations, for example, by using devices with sufficient available processing resource (e.g., processing load or processing bandwidth), capacity, and/or capability to perform DSP in place of exclusive reliance on an aggregator that may have more limited bandwidth, capacity, and/or capability to perform all DSP required for the audio system. These are non-limiting examples of advantages of the audio system described herein, and other advantages will be apparent based on descriptions herein.

These features, along with many others, are described in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an example audio system for networked DSP;

FIG. 2 shows an example audio system using feature groups for networked DSP;

FIG. 3 shows an example computing device for performing networked DSP;

FIG. 4A shows an example method to configure an audio system;

FIG. 4B shows an example method to configure an audio system;

FIG. 5 shows an example method for configuring networked DSP features;

FIG. 6 shows an example method for configuring networked DSP features;

FIG. 7 shows an example audio system for networked DSP, including an indication of example features that may be distributed (for example, load-balanced) amongst the devices of the audio system;

FIG. 8 shows an example audio system for networked DSP, in which at least some of the endpoints may be located in different zones;

FIG. 9 shows an example audio system for networked DSP, including an indication of example features that may be distributed (for example, load-balanced) amongst the devices of the audio system and where at least some of the endpoints may be located in different zones;

FIG. 10 shows an example audio system for networked DSP that includes a plurality of aggregators, and where at least some of the endpoints may be located in different zones; and

FIG. 11 shows an example method to configure an audio system.

FIG. 12 shows an example method to enable or disable supplemental feature implementation based on zone status.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure. It is noted that various connections between elements are discussed in the following description. It is noted that these connections are general and, unless specified otherwise, may be direct or indirect, wired or wireless, and that the specification is not intended to be limiting in this respect.

As described in more detail herein, an audio system may be provided that comprises an aggregator and a plurality of endpoints. DSP features related to audio may be performed by the aggregator and/or by the endpoints in a distributed/networked manner that may be controlled by the aggregator. For example, rather than a single device/component performing all DSP features for an audio system (e.g., in a room, hall, building, group of buildings or campus, indoor or outdoor venue, etc.), DSP in the audio system described herein may be distributed across a plurality of devices/components such as endpoints (e.g., in addition to or in place of DSP by an aggregator) based on various system requirements, capabilities, available processing resources (e.g., processing load or processing bandwidth), and/or other conditions. Load-balancing may be used to determine the distribution of DSP features. For example, features may be load-balanced to achieve a particular usage of processing resources across multiple devices in the audio system. For example, it may be desired that one or more particular devices in the audio system be assigned to perform DSP features such that implementing the DSP features would not utilize more than a threshold amount (e.g. percentage) of processing resources of that device. As another example, it may be desired that one or more particular devices in the audio system be assigned to perform DSP features such that implementing the DSP features would not cause the device to generate more than a threshold amount of heat and/or noise.

DSP may comprise any digital signal processing of an audio signal and/or of information relating to an audio signal. For example, analog audio signals may be converted into digital audio signals, and one or more processors may perform DSP on the digital audio signals. Additionally or alternatively, DSP relating to the audio signals may be performed, such as to determine a source, location, and/or any other information relating to an audio signal. DSP may comprise one or more operations corresponding to audio-related features such as mixing, filtering, equalization, noise reduction, acoustic echo cancellation, automatic gain control, delay, compression, surround sound features, using audio to control other operations such as non-audio operations (e.g., using audio to direct a camera at an audio source, to activate a camera and/or a recording function in a room where audio is detected, and/or to perform some other activity associated with audio), and the like. These are non-exhaustive examples of DSP features, and generally, any other type of DSP features may be used in the disclosed audio system that may improve the perceived sound quality of one or more audio signals.

Performance of DSP may be distributed across one or more aggregator devices and one or more endpoint devices. For example, an endpoint device may detect audio using a first DSP feature (e.g., activity-based operation associated with audio). The endpoint device may communicate with an aggregator device to inform the aggregator device about the audio detection. Based on the communication of the audio detection, the aggregator device may perform a second DSP feature (e.g., mixing, filtering, equalization, noise reduction, noise cancellation, etc.) on the detected audio. For example, if the detected audio is a noise source, the noise may be detected by a first component (e.g., an endpoint device) by performing a first DSP feature, and the noise may be canceled and/or reduced by a second component (e.g., an aggregator or another endpoint) by performing a second DSP feature. Additionally or alternatively, the second component may receive other information from other components (e.g., other endpoint devices) that may perform one or more additional DSP features (e.g., specific location identification of an audio source that may be a noise source) or the first DSP feature (e.g., noise detection), and the second component may corroborate the noise detection by the first component by using the other information from the other components and/or further refine the detected audio (e.g., using the second DSP feature and/or one or more other DSP features). For example, based on the initial information of the detected audio, and based on the additional information received from the other components, the second component (e.g., an aggregator device) may perform one or more DSP features on the audio to provide an output audio signal with an overall improved perceived quality relative to audio received by one or more of the other components (e.g., by one or more other endpoint devices) and/or to control one or more components of the audio system to perform a function (e.g., exclude and/or reduce a level of a noise source in a mix, steer an array microphone beam away from the direction of a noise source, etc.) that may improve the overall perceived audio quality. These are non-limiting examples of DSP coordination, and any other distributed DSP may be performed across components/devices in the audio system described herein. An audio system is described in further detail and by way of example with respect to the following figures.

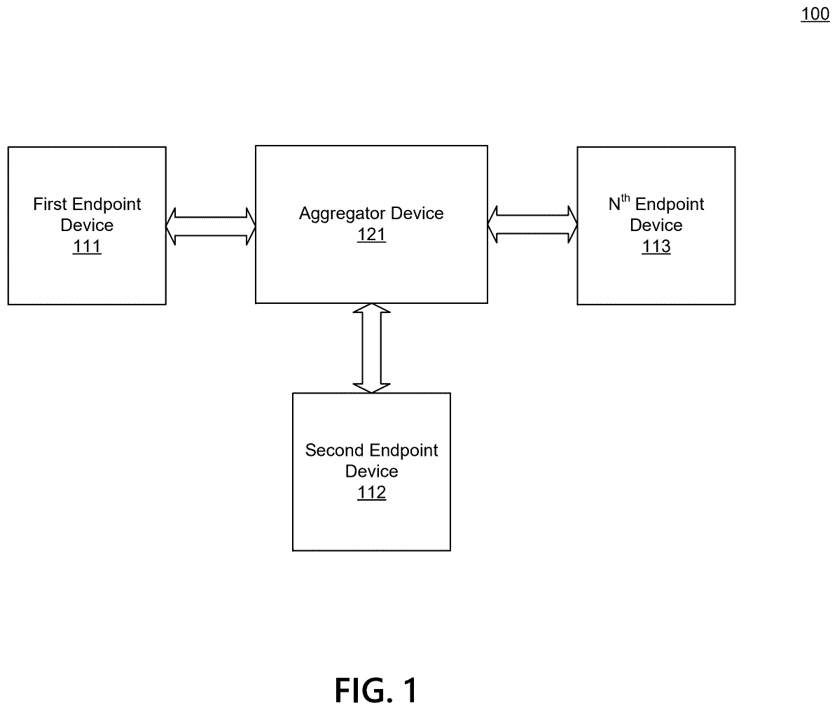

FIG. 1 shows an example audio system 100. The audio system 100 may be configured for distributed DSP, and components of the audio system 100 may communicate (indicated by the arrows in FIG. 1) directly and/or indirectly with other components of the audio system 100. The audio system 100 may comprise components such as at least one aggregator device 121 and a plurality of endpoint devices 111-113. The audio system 100 may comprise any combination of audio devices for networked communication within an environment (e.g., in a room, hall, building, group of buildings or campus, indoor or outdoor venue, etc.). The plurality of endpoint devices may comprise any quantity of endpoint devices, such as a first endpoint device 111, a second endpoint device 112, and up to an Nth endpoint device 113, where N may be any positive integer. In at least some examples, the aggregator device 121 may comprise a different device as the endpoint devices 111-113. In at least some other examples, the aggregator device 121 may itself be an endpoint device, such that an endpoint device may operate as the aggregator device 121 by performing an aggregating function as well as an endpoint function. In still other examples, one or more endpoints may correspond to logical operations on a single computing device, and/or one or more endpoints may be combined with an aggregator in a single computing device. Thus, the aggregator device 121 and the plurality of endpoint devices 111-113 shown in FIG. 1 may correspond to separate physical computing devices, or one or more of such devices may be combined (such as being logical operations, software implementations, and/or hardware elements) within a single computing device. For example, the aggregator device 121 and the first endpoint device 111 may be physically combined as a single physical device contained within a single physical housing.

The aggregator device 121 may operate to control at least some operation of the plurality of endpoint devices 111-113. For example, the aggregator device 121 may communicate with one or more of the plurality of endpoint devices 111-113 (e.g., one, some, or all of the endpoint devices). The aggregator device 121 may communicate with the endpoint device(s) 111-113 via one or more communication channels, such as via a non-time-critical protocol (e.g., Architecture for Control Networks, ACN). The aggregator device 121 may be configured to receive data from the endpoint device(s) 111-113. Additionally or alternatively, the aggregator device 121 may be configured to send data to the endpoint device(s) 111-113. One or more connections, links, channels, and/or time-critical data protocols (e.g., Dante, AES67, Real-Time Transport Protocol (RTP), etc.) may be used to communicatively connect the endpoint devices 111-113 (e.g., via the aggregator 121). For example, one or more subscriptions may be made on the aggregator device 121 for channel(s) receiving data from the endpoint device(s) 111-113. One or more subscriptions may be made on one or more endpoint device(s) (e.g., one or more of 111-113) for sending data to one or more other endpoint device(s) (e.g., another one or more of 111-113). One or more communication channels (e.g., Dante channel(s) or the like) may be allocated as, e.g., fixed channels. In at least some examples, the aggregator device 121 may be configured with a plurality of input channels to communicate with a corresponding plurality of endpoint devices. For example, the aggregator device 121 may be configured with three input channels to communicate with three endpoint devices 111, 112, and 113 (e.g., where N in FIG. 1 may be three, although N may be any other positive integer). The aggregator device 121 may be configured with any other quantity of input channels. The aggregator device 121 may be configured with at least one output channel. In at least some examples, the aggregator device 121 may be configured with one output channel that may be used to communicate with each of a plurality of endpoint devices (e.g., 111-113). In other examples, the aggregator device 121 may be configured with a plurality of output channels that may be used to communicate with a plurality of endpoint devices (e.g., 111-113). A quantity of output channels may be different from (or the same as) a quantity of endpoint devices with which the aggregator device 121 may be configured to communicate.

The plurality of endpoint devices 111-113 may be configured (e.g., pre-configured and/or configured by one or more aggregator devices) to work together as audio processing devices to perform one or more audio-related DSP features in a networked manner. For example, at least some of the plurality of endpoint devices 111-113 (and/or the aggregator device 121) may be configured to perform one or more operation(s) such as: discover feature availability, determine feature and/or device compatibility, control feature and/or device behavior (e.g., on a local and/or remote device), configure real-time data exchange with one or more other devices in the system, dynamically update devices in the system (e.g., add, remove, configure, etc.), and/or monitor the status of devices in the system. A feature may correspond to an audio processing feature, such as audio transmission/reception (e.g., single microphone, array microphone, multi-array, etc.), mixer (e.g., a networked auto-mixer), noise reducer (e.g., networked noise reduction), any audio feature referenced herein, and/or any other audio feature. Additionally or alternatively, a feature may correspond to a feature associated with audio, such as audio source detection, audio source location, statistics derived from one or more audio signals (e.g., time-averaged audio signal level in specific frequency band(s)) and/or operation relating to audio (e.g., controlling positioning and/or other operation of a video camera configured to receive images/video and audio). The audio system 100 may operate by the aggregator device 121 communicating (e.g., wired and/or wirelessly) with the plurality of endpoint devices 111-113 to configure one or more endpoint devices (e.g., first endpoint device 111 and second endpoint device 112) to each perform at least a portion of DSP for at least one feature, whereby collective DSP for the feature(s) is divided among the two or more devices (e.g., two endpoint devices, one aggregator device and one endpoint device, etc.). By performing such networked DSP, for example by load-balancing DSP features across devices of the system 100, the system 100 may provide various advantages, such as but not limited to improved efficiency, enhanced performance, and/or increased reliability, as described further herein.

After initial configuration and subscribing to the data, the aggregator device 121 may be able to reestablish (e.g., automatically reestablish) a connection with an endpoint device (e.g., 111-113), for example, after the endpoint device reboots and returns to being online. In at least some examples, endpoint device(s) (e.g., 111-113) may have a subscription to the aggregator device 121 (e.g., for receiving data) such that the endpoint device(s) may retain information about the aggregator device 121 (e.g., channel name, device name, etc.). Various configurations may be implemented in the system 100, for example, in order to accommodate one or more additional channels being added to a channel list while maintaining a fixed usage of channels. In at least some configurations, the system 100 may be configured to accommodate one or more devices (e.g., endpoint devices 111-113, aggregator device 121, etc.) being rebooted, removed (e.g., by removing power), and/or reconfigured (e.g., to part of another feature group).

One or more aggregator devices 121 may be configured to control which DSP features are performed by the various endpoint device(s) 111-113. Additionally or alternatively, at least some endpoint devices (e.g., 111-113) may be configured to operate as an aggregator device in the system 100. For example, the Nth endpoint device 113 may operate as both an aggregator device and an endpoint device. The endpoint devices 111-113 may operate as a transmitting device (e.g., microphone), a receiving device (e.g., loudspeaker), and/or as a transceiver device (e.g., a microphone having a transceiver, a speaker/loudspeaker having a transceiver, etc.). Each component (which may be implemented as or otherwise include, for example, a computing device) in the system 100 may be configured for one or more roles (e.g., specific role(s)). At least some endpoint devices 111-113 may be able to be configured to support different roles (e.g., microphone, relay device, audio processing device, etc.). Computing devices in the system 100 (e.g., 111-113, 121) may be made aware of their role in the system 100, and/or of other computing devices'roles in the system 100, for one or more networked features (e.g., a specific network feature). For at least some features, a computing device in the system 100 may take on multiple roles and/or may perform multiple features.

The system 100 may comprise two or more components (e.g., computing devices) that support networked DSP features related to audio. For example, each endpoint device of the plurality of endpoint devices 111-113 may comprise one or more of: audio processing device(s), microphone(s), aggregator(s), mixer(s), noise reducer(s), speaker(s), and/or DSP device(s). Networked DSP features may comprise DSP processing on multiple devices that may be located in the same room, hall, building, group of buildings or campus, indoor or outdoor venue, etc. and that may operate together as a single system (e.g., system 100). Additionally or alternatively, networked DSP features may comprise DSP on multiple devices that may be located in different rooms (and/or different geographic areas) while still operating together as a single system. For example, the first endpoint device 111 may be located in the same room (and/or same general area) as the second endpoint device 112. Alternatively, the first endpoint device 111 may be located in a first room (and/or first geographic area) while the second endpoint device 112 may be located in a second room (and/or second geographic area) different from the first room/area. The networked DSP features may be performed by multiple devices (e.g., 111-113) communicatively connected (e.g., wired or wirelessly) on the same network (e.g., as system 100). The networked DSP features may be controlled (at least in part) by at least one aggregator (e.g., 121).

The endpoint devices 111-113 and/or the aggregator 121 may communicate via one or more channels, ports, protocols, and/or signals. For example, the endpoint devices 111-113 and/or the aggregator 121 may exchange feature configuration information via a first channel/port/protocol/signal, such as via non-time-critical protocol (e.g., Architecture for Control Networks (ACN) protocol). The endpoint devices 111-113 and/or the aggregator 121 may exchange time-critical information via a second channel/port/protocol/signal, such as via a time-critical protocol (e.g., Dante, AES67, real-time transport protocol (RTP)), which may be used for real-time audio DSP. At least some features (e.g., each feature) may have dedicated real-time data links (e.g., a collection of dedicated channels for a specific feature). Additionally or alternatively, a group (e.g., “pool”) of available channel(s) may be identified to the endpoint devices 111-113 and/or to the aggregator 121, and an endpoint and/or an aggregator may be configured to send data from multiple features over the available channel(s) (e.g., multiplexed communications). In at least some examples, each DSP feature may have its own corresponding/dedicated link. In at least some other examples, a feature may share one or more links with one or more other features, whereby communications for a feature may be multiplexed with communications for another feature on a same link. For example, communications may comprise packet communication in which a packet may comprise a plurality of fields, wherein each field of at least some of the plurality of fields may correspond to a dedicated field, within the packet, for a particular feature. A link for communication between devices (e.g., between first endpoint device 111 and aggregator 121, between second endpoint device 112 and aggregator 121, and/or between either of first/second endpoint devices 111/112 and Nth endpoint device 113 via aggregator 121, etc.) may comprise both transmit channel(s) from the aggregator device (e.g., 121) to the endpoint device(s) (e.g., 111, 112, 113) and/or transmit channel(s) from the endpoint device(s) (e.g., 111, 112, 113) to the aggregator device (e.g., 121).

Each endpoint device of the plurality of endpoint devices 111-113 may be configured to perform DSP for at least one feature. An advertisement operation may comprise communicating with a plurality of computing devices (e.g., endpoint devices, aggregator(s)) to indicate one or more roles and/or features for which a particular computing device is configured to perform. An endpoint and/or an aggregator device may communicate to other computing devices in the system 100 (e.g., endpoint devices, aggregator(s)) its feature version compatibility handling, such as for determining whether the particular computing device may perform DSP for one or more features. An endpoint and/or an aggregator may communicate with other computing devices in the system 100 (e.g., endpoint devices, aggregator(s)) to enable and/or disable control of a computing device, and/or to activate and/or deactivate a computing device, such as for performing DSP for one or more features. Feature activation and/or deactivation may enable real-time data associated with the feature to be produced and/or consumed by computing device(s) in the system 100. Computing devices (e.g., endpoint device(s), aggregator(s)) participating in a feature may be dynamically updated (e.g., added and/or removed). Such dynamic updating may be performed without removing one or more communication links between the computing device(s) (e.g., without tearing down a system). A real-time data link setup (e.g., via Dante, AES67, RTP, and/or any other time-critical channel) may be established between the endpoints 111-113 and aggregator(s) 121. Monitoring may be performed in which a status of computing devices (e.g., endpoint devices, aggregator(s), etc.) in the system 100 may be monitored. Error handling may be performed such as by re-routing and/or reallocating DSP features across computing devices, for example, if one or more computing devices is determined to no longer be available (e.g., powered off, disconnected from the network, unresponsive).

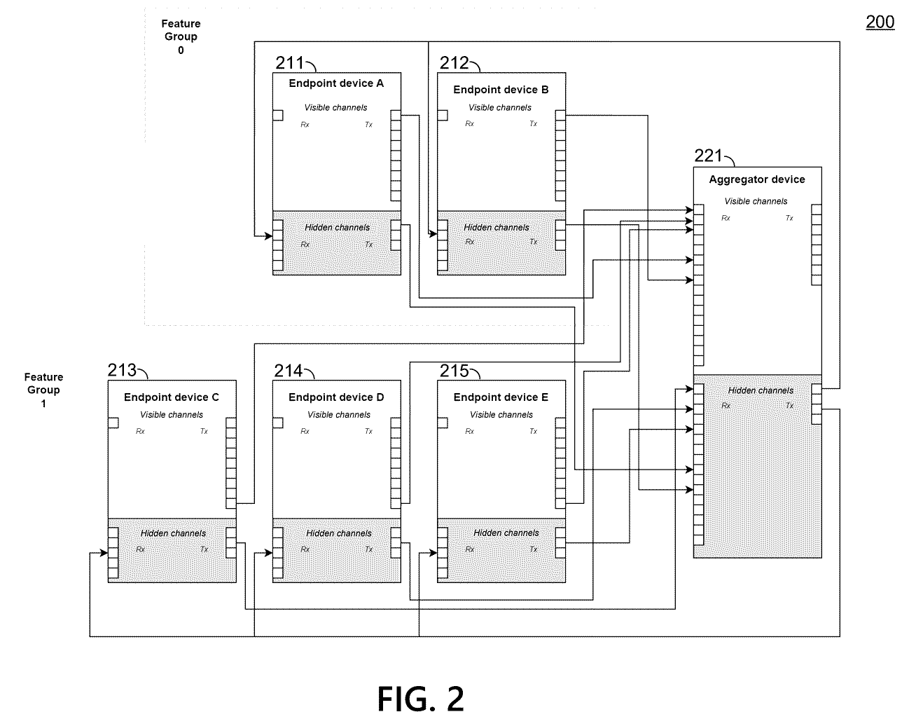

FIG. 2 shows an audio system 200. The audio system 200 may use feature groups for networked DSP. The audio system 200 may correspond to the audio system 100 described with respect to FIG. 1, descriptions of which are incorporated by reference here. The audio system 200 may comprise a plurality of endpoint devices 211-215 and at least one aggregator device 221. The endpoint devices 211-215 may correspond to the endpoint devices 111-113 described with respect to FIG. 1 and/or the at least one aggregator device 221 may correspond to the aggregator device 121 described with respect to FIG. 1, descriptions of which are incorporated by reference here. At least some endpoint devices 211-215 may be grouped by feature. A feature group ID may refer to an index of a particular feature group (e.g., 0 to M−1, where M is a maximum number of groups supported by an aggregator device for a particular feature). A feature group may refer to a collection of devices working together on a specific feature. A feature group may use a plurality of aggregation links, which may generally correspond to any real-time data link (e.g., via Dante, AES67, RTP, and/or any other time-critical channel). Any quantity of groups may be used, for example, based on a quantity of DSP features for which endpoint devices may be configured. For example, a plurality of endpoint devices 211 and 212 (e.g., Endpoint device A and Endpoint device B) may be configured to perform DSP for an initial feature, and these endpoint devices may be grouped as Feature Group 0. A plurality of endpoint devices 213, 214, and 215 (e.g., Endpoint device C, Endpoint device D, and Endpoint device E) may be configured to perform DSP for another feature (e.g., different from a feature of Feature Group 0) and/or another (independent) instance of the same feature in the same or different room, and these endpoint devices may be grouped as Feature Group 1. While two feature groups are shown in FIG. 2 (e.g., Feature Group 0 and Feature Group 1), any number of feature groups may be used.

As another example, a feature group may refer to a group of devices in a particular location and/or area, such as in a room, hall, building, zone, etc. Each device within that location and/or area may perform one or more DSP features collectively as a feature group. In this manner, a plurality of devices may be configured (e.g., enabled, activated, disabled, deactivated, controlled, etc.) as a group. For example, all devices in a room may have DSP features turned on after audio is detected in the room and/or after a person is detected in the room, and/or all devices in the room may have DSP features turned off after no audio is detected in the room (e.g., after a time duration) and/or after no motion is detected in the room (e.g., after a time duration). As another example, at least some devices in a feature group may perform the same or complementary/related functions and/or the same or complementary/related DSP features that may be controlled (e.g., by an aggregator device) in a networked manner. For example, devices in a feature group may perform the same (or similar) DSP feature(s), wherein each device in the feature group may perform the same one or more DSP features but in possibly different/distinct ways, such that a device's performance of a DSP feature may be complementary to other device performance for that DSP feature within the feature group. For example, some devices may have microphones that may be used to detect a presence and/or location of an audio source in a room (e.g., a person speaking, or a source of a noise such as an air conditioner, siren, fan, etc.) and may have otherwise relatively limited capability (e.g., low sound quality), whereas other devices may have more robust microphones configured to receive/process/send audio of a higher perceived quality. Both types of microphones may operate to perform DSP as a single DSP feature group, for example, specific to an area in which they are located. But each type of device's DSP may perform in different/distinct ways within that DSP feature group (e.g., noise detection versus audio signal enhancement). As another example, audio may be used to direct a camera at an audio source whereby endpoint devices A and B (e.g., Feature Group 0) may be in an area of one camera and endpoint devices C, D, and E (e.g., Feature Group 1) may be in an area of a second camera. In such an example, Feature Group 0 may be used to direct the positioning of the first camera, and Feature Group 1 may be used to direct the positioning of the second camera. As a result, both feature groups may be performing the same feature/functionality, but independently of each other.

Endpoint devices may be grouped by multiple DSP features such that inclusion in a feature group may correspond to being configured for a certain plurality of DSP features. At least some DSP features may be included in a plurality of different groups of endpoint devices (e.g., each feature group need not be mutually exclusive as to the DSP features that are included in it relative to other feature groups). The at least one aggregator device 221 may be configured to control allocation/assignment of DSP features to be performed by each group (e.g., by Feature Group 0 and by Feature Group 1) on a per-group basis. Additionally or alternatively, the at least one aggregator 221 may be configured to control allocation/assignment of DSP features to be performed by each endpoint device (e.g., each of endpoint devices 211-215). By grouping one or more DSP features in a feature group, the system 200 may be able to more efficiency control the DSP feature(s) by simplifying communications and coordinating operation across a plurality of devices. For example, a feature group corresponding to a particular area (e.g., a first zone or area of a room) may be controlled and coordinated for DSP as a group (e.g., first feature group), whereas a feature group corresponding to another area (e.g., a second zone or area of a room) may be controlled and coordinated for DSP as a different group (e.g., second feature group).

One or more of the plurality of endpoint devices 211-215 may perform transmission (Tx) and/or reception (Rx) using one or more visible channels and/or using one or more hidden channels. Visible and hidden channels may both be real-time data links (e.g., via Dante, AES67, RTP, and/or any other time-critical channel). “Visible” channels may refer to user-facing channels. “Hidden” channels may refer to internal, non-user-facing channels. Additionally or alternatively, the at least one aggregator 221 may perform transmission (Tx) and/or reception (Rx) using one or more visible channels and/or using one or more hidden channels. While some endpoint devices (e.g., 211-215) and an aggregator (e.g., 221) are shown in FIG. 2 having a particular quantity of transmission and/or reception channels (e.g., 211 is shown with one visible Rx channel, nine visible Tx channels, 5 hidden Rx channels, and 3 hidden Tx channels), each endpoint device (e.g., 211-215) and/or each aggregator (e.g., 221) may communicate (e.g., transmit and/or receive) using any quantity of visible Tx channels, any quantity of visible Rx channels, any quantity of hidden Tx channels, and/or any quantity of hidden Rx channels. While FIG. 2 shows one aggregator (e.g., 221), the system 200 may comprise any quantity of aggregators. For example, the system 200 may comprise a secondary aggregator per each feature group, wherein the secondary aggregator may configure each endpoint device within a particular feature group. A primary aggregator may be included in the system 200 that may configure one or more secondary aggregators and/or one or more endpoint devices.

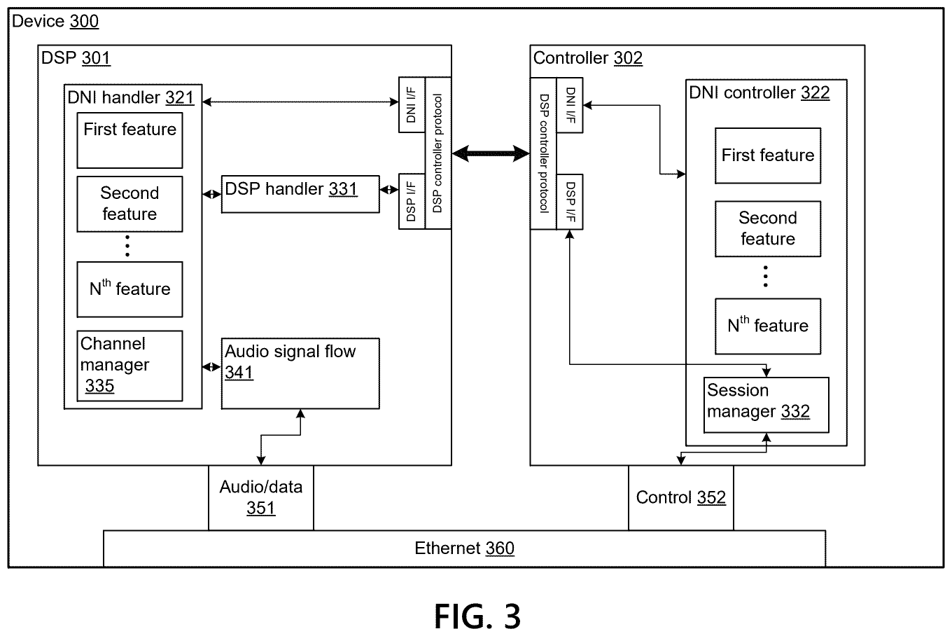

FIG. 3 shows a computing device 300. The computing device 300 may comprise any device configured to perform operations described herein, such as operations relating to networked DSP. For example, the computing device 300 may be an endpoint device, such as any of the endpoint devices described herein (e.g., 111-113, 211-215). Additionally or alternatively, the computing device 300 may be an aggregator, such as any of the aggregators described herein (e.g., 121, 221). The computing device 300 may comprise a DSP 301 and a controller 302. The DSP 301 may perform DSP features, including any of the audio processing and/or audio-related features described herein. “DSP” is used herein to refer to “digital signal processing” generally, and while such digital signal processing may be performed by one or more processors, DSP is used herein in its broadest sense to refer to digital signal processing generally. For example, the DSP 301 may comprise one or more digital signal processors or may comprise processing within one or more digital signal processors. The DSP 301 may comprise one or more of: a DSP networked infrastructure (DNI) handler 321, a DSP handler 331, a DNI interface (e.g., DNI I/F), a DSP interface (e.g., DSP I/F), a DSP controller protocol interface, and/or an audio signal flow 341. In at least some examples, the DNI handler 321 and the DSP handler 331 may be combined into a common element, component, and/or logic. The audio signal flow 341 may be configured to communicate audio signaling to/from the DNI handler 321 and an audio/data interface 351. The audio signal flow 341 may perform real-time data packing/unpacking for interfacing with the audio/data interface 351. The audio/data interface 351 may be used for communicating (e.g., sending/receiving) audio data and/or non-audio data (e.g., real-time non-audio data). The audio/data interface 351 may be coupled to an Ethernet interface 360 for communication with one or more other computing devices in an audio system (e.g., system 100, system 200, etc.). The DNI handler 321 may be configured to perform one or more DSP features, such as a first feature, second feature, and/or up to an N^{th} feature, where N is any integer greater than zero. DSP features may have corresponding feature controllers that control corresponding logic, that may be required for the particular feature, within the DSP handler 321. Feature logic may handle commands for setting up a feature, controlling the DNI handler 321 and DSP handler 331, and/or for setting up communication channels for the device 300. The DNI handler 321 may comprise a channel manager 335 that may manage channels for the audio signal flow 341.

The controller 302 may control operations for DSP features, including any of the audio processing and/or audio-related features described herein. The controller 302 may comprise one or more of: a DNI controller 322, a session manager 332 (e.g., as part of or separate from the DNI controller 322), a DNI interface (e.g., DNI I/F), a DSP interface (e.g., DSP I/F), and/or a DSP controller protocol interface. The DNI controller 322 may be responsible for enabling, monitoring, and/or disabling features across devices. The DNI controller 322 may start monitoring devices participating in a feature, for example, after that feature is enabled. The DNI controller 322 may monitor for any new device(s) that may be a candidate for the feature. The session manager 332 may monitor for device availability and the sessions to the device. The session manager 332 may perform real-time data link setup. The session manager 332 may report the status of the feature. Monitoring by the session manager 332 may differ depending on whether a device is an aggregator or an endpoint. For example, if the device is an aggregator device, the DNI controller 322 in the device may monitor all endpoint devices (e.g., all endpoint devices in communication with the aggregator device). In such a device, the DNI controller 322 may monitor status of feature(s) (e.g., to which the device is subscribed during enabling of the feature) to determine whether the feature(s) is/are still enabled and active. In such a device, the session manager 332 may monitor the device availability and the sessions to the device, and may report the status back to the DNI controller 322. If the device is an endpoint device, the DNI controller 322 may only monitor an aggregator device in communication with the endpoint device. In such a device, if the feature(s) that the device is participating in has been deactivated and disabled, an aggregation link may be torn down (e.g., in the DNI controller 322).

The DNI controller 322 may be inquired about the devices configured and/or available for participating in one or more feature groups for the one or more features, for example, if one or more features are configured in an aggregator device (e.g., 121, 221). If a list of available and/or compatible devices has been established, the DNI controller 322 may be enabled for the feature(s), and the feature(s) may be enabled in each endpoint device capable of performing such feature(s). The session manager 332 may notify the DSP 301 about all available device channel links. Thereafter, based on a real-time data link setup request from the DNI controller 322 for a particular feature, the DSP 301 may request the session manager 332 to setup the channels that may be required for the feature. The DNI controller 322 may be responsible for disabling one or more features in an aggregator device and/or in one or more endpoint devices.

The session manager 332 may be configured to control one or more sessions corresponding to one or more DSP features. The session(s) may be created dynamically. The session manager 332 may be configured to set up communication channels that may be required for a networked DSP feature. For example, channels may be requested by the DSP 301 after a feature has been enabled (e.g., after being enabled and receiving a real-time data link setup request from the DNI controller 322). The session manager 332 may be responsible for monitoring a connection (e.g., wireless connection and/or wired connection) and/or connected devices (e.g., wirelessly connected devices and/or wired connected devices). The session manager 332 may communicate (e.g., to the DNI handler 321 and/or to feature logic) if/when one or more connections are not working as expected and/or if/when a device goes offline. The session manager 332 may configure communications between the controller 302 and the DSP 301 via the DSP interface (e.g., DSP I/F) and/or the DSP controller protocol interface of the respective controller 302 and/or DSP 301. The session manager 332 may be configured to communicate via a control interface 352. The control interface 352 may be coupled to the Ethernet interface 360 for communication with one or more other computing devices in an audio system (e.g., system 100, system 200, etc.). The control interface may be configured for synchronous control information, such as via a real-time control interface (e.g., Dante, RTP, etc.), and/or for asynchronous control information, such as for a non-real-time control interface. The DNI controller 322 may be configured to perform one or more DSP features, such as a first feature, a second feature, and/or up to an Nth feature, as shown in FIG. 3, where N is any positive integer. DSP features may have corresponding feature controllers that control corresponding logic, required for the particular feature, within the DNI controller 322. The DNI controller 322 may be configured to start and/or control features across devices in an audio system (e.g., 100, 200). Feature logic may handle commands for setting up a feature, controlling the DNI controller 322, and/or for setting up communication channels for the device 300. While not shown, the controller 302 may be configured to communicate with an external controller interface (e.g., a third-party controller interface (TPCI)), which may provide for external control of the device 300.

The DNI controller 322 may be responsible for enabling, monitoring, and/or disabling features across devices (e.g., 300). For example, if a feature is configured in an aggregator device (e.g., 121, 221), the feature controller may inquire the DNI controller 322 about the devices configured and/or available for participating in a feature group. If a list of available and/or compatible devices has been established, the feature controller may enable the feature in a respective DNI controller (e.g., 322) in each endpoint device (e.g., 111-113, 211-215, 300). The DNI controller 322 may then notify the DSP 301 about channel links (e.g., about all available device channel links). As a result, each device (e.g., 300) may know/determine the role(s) of other device(s) for a feature and may be able to notify the DSP 301 that a given feature is enabled. The DSP 301 may then request the DSP handler 331 to setup the channel(s) required for the feature. The DNI controller 322 may similarly be responsible for disabling the feature in both the aggregator device and the endpoint device(s). The channel manager 335 may setup and/or manage the channel(s) required for the feature, for example, based on communication with the DSP handler 331.

The session manager 332 may be responsible for setting up the communication channels needed for one or more networked features. These channels may be requested by the DSP 301 after a feature has been enabled. The session manager 332 may be responsible for monitoring the connection and the devices connected. For example, if any connections are not working as expected and/or if a device goes offline, the DNI controller 322 and the features logic may be notified about the status of the connection.

A session may be created for each connection (e.g., for each channel connection) between an aggregator device and an endpoint device. Sessions may be reception (RX), transmission (TX), and/or bidirectional connections. For example, a session may be an RX connection from the perspective of an aggregator device and a TX connection from the perspective of an endpoint (e.g., an RX session may comprise data being transmitted from an endpoint and received by an aggregator); and/or a session may be a TX connection from the perspective of an aggregator device and an RX connection from the perspective of an endpoint (e.g., a TX session may comprise data being transmitted from an aggregator device and received at an endpoint device). An RX session may be a connection where an aggregator device is configured to receive data from an endpoint device. A TX session may be established when an aggregator device determines to send data to an endpoint device. In at least some examples, only RX sessions may be supported. In at least some other examples, TX sessions may be supported (e.g., in addition to RX sessions).

Sessions may be requested (e.g., by the DSP 301) by sending (e.g., to the controller 302) a request to create a session. After the session has been created, the controller 302 may send a response to the request. The response may comprise, for example, an identifier (ID) and/or status of the newly created session. A session may be maintained at least until the DSP 301 requests the session to be torn down (e.g., by sending a request to close the session) and/or at least until the device 300 reboots.

After a session is established, the controller 302 may monitor the session. The controller 302 may send an update (e.g., a session condition update) to the DSP 301, for example, if the condition of the session changes. An update may happen, for example, if an endpoint device reboots and/or if a real-time data link (e.g., a Dante subscription) is not working correctly. The controller 302 may continue monitoring and/or attempt to reestablish a session, for example, if the connection to an endpoint device is not working.

A device (e.g., 300) may cancel (e.g., automatically cancel) all existing subscriptions on the device, for example, if the device reboots. For example, if a device does not know whether a feature is still running, it may tear down all connections. It may be the up to an aggregator device (e.g., 121, 221) to reestablish the channels required for an active feature. If the aggregator device starts up, the feature may need to setup all RX and TX connections. If an endpoint device (e.g., 111-113, 211-215) starts up, the aggregator device, if still active, may reestablish any TX, RX, and/or bidirectional session to the endpoint device.

An audio system (e.g., 100, 200) may comprise a plurality of computing devices operating as one or both of an endpoint device (e.g., 111-113, 211-215) and an aggregator device (e.g., 121, 221), wherein the computing device may comprise one or more processors, memory storing instructions that may be executed by the one or more processors, and one or more of the DNI handler 321, the DSP handler 331, and/or the DNI controller 322. For example, the device 300 may be configured with additional or fewer features than shown in FIG. 3, and such a device may comprise one or more of the DNI handler 321 and/or the DNI controller 322 to perform any of the operations described herein with respect to one or more DSP features. In at least some examples, functionality described herein with respect to the DSP 301 may be performed by the controller 302, and/or functionality described herein with respect to the controller 302 may be performed by the DSP 301.

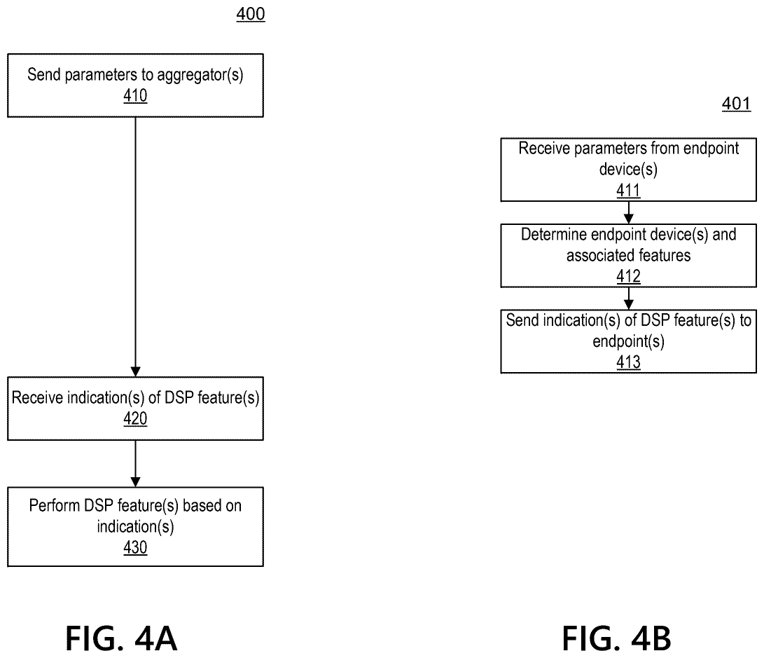

FIG. 4A and FIG. 4B show example methods to configure an audio system. The audio system may correspond to any audio system described herein (e.g., system 100, system 200). FIG. 4A shows an example method 400 that may be performed by one or more endpoint devices (e.g., 111-113, 211-215). FIG. 4B shows an example method 401 that may be performed by an aggregator device (e.g., 121, 221). Methods 400 and 401 may correspond to a combined method for configuring an audio system comprising a plurality of endpoint devices and at least one aggregator device. At step 410, one or more endpoint devices may send parameters to one or more aggregators. At step 411, an aggregator device may receive parameters from one or more endpoint devices. At step 412, the aggregator may determine endpoint device(s) and associated features for the respective endpoint device(s). The associated features may be features that the endpoint device may be configured and/or capable to perform. The associated features may be determined by distributing (e.g., by load balancing across multiple devices based on their available processing resources) desired features amongst a plurality of the endpoint devices and/or one or more aggregator devices in a manner that may achieve a particular goal, such as by taking into account processor resource usage, power consumption, and/or heat generation across the devices. At step 413, the aggregator device may send one or more indication(s) of DSP feature(s) to the endpoint device(s). At step 420, one or more endpoint devices (e.g., the endpoint device(s) that previously sent the parameters at step 410) may receive indication(s) of DSP feature(s). At step 430, the one or more endpoint devices may perform the DSP feature(s) based on the indication(s). Step(s) shown and described with respect to FIG. 4A and/or FIG. 4B may be performed in any order and/or may be omitted.

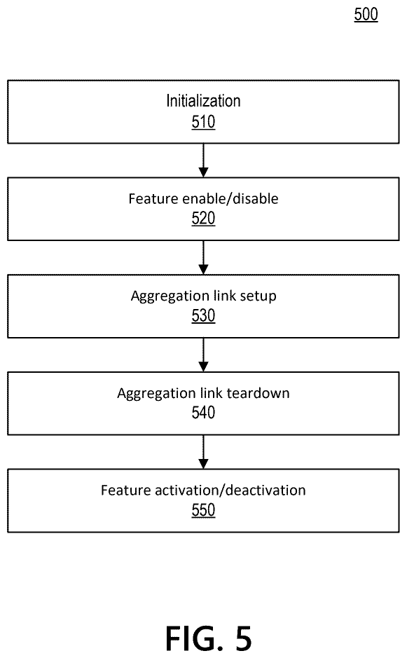

FIG. 5 shows an example method for configuring networked DSP features. A method 500 may be performed by one or more devices described herein (e.g., 111-113, 121, 211-215, 300). At step 510, a device may perform an initialization operation. The initialization operation may be performed by an endpoint device prior to step 410 in FIG. 4A. Additionally or alternatively, the initialization operation may be performed after step 411 in FIG. 4B. In at least some examples, an aggregator device may need to perform (at least part of) the initialization for each endpoint device. New endpoint devices may be dynamically added at any time (e.g., at a future time), such that not all initialization may happen at the same time. The initialization operation may comprise a controller (e.g., controller 302 described with respect to FIG. 3) communicating with a DSP (e.g., DSP 301 described with respect to FIG. 3) to request and/or receive information such as a version (e.g., DNI version) and/or supported feature(s) of the DSP. The controller may query an interface version (e.g., DNI interface version). Querying an interface version may comprise sending a request message. The request message may request information such as a parameter type, identifier/ID, and/or interface version. A DSP may receive the request. Based on receiving the request, the DSP may determine (e.g., by looking up in memory) an interface version. The DSP may send a response to the controller. The controller may receive the response, which may include a parameter type report, an identifier/ID, and/or an interface version. The controller may query one or more supported features (e.g., after querying the interface version). For example, the controller may send a request for one or more supported features, the DSP may determine (e.g., by looking up in memory) the supported feature(s), and the DSP may send (and the controller may receive) a response comprising an indication of the supported feature(s). The controller and/or the DSP may repeat the request, determine/look-up, and response process for each feature that may be supported (e.g., in a loop). Additionally or alternatively, the controller and/or the DSP may perform the request, determine/look-up, and response process for all features that may be supported together (e.g., in parallel and/or in the same messaging for all features). The controller and/or the DSP may discontinue the request, determine/look-up, and response process for the supported feature(s), for example, based on a determination that all supported features have been identified and/or that all features have been evaluated for whether they are supported.

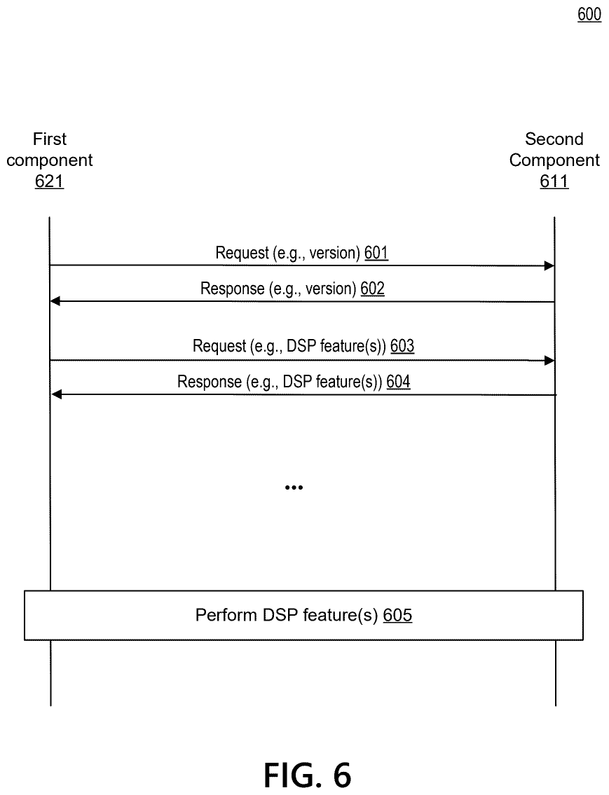

The initialization process may include the controller storing information received from the DSP, which may enable other devices to enquire about supported features for a host device. In at least some examples, as a default, the controller may be booted up with all features disabled and no sessions to other devices. In such examples, an aggregator device may maintain/persist a feature, for example, if a feature must be maintained/persisted. The aggregator may reestablish with one or more endpoints connection(s) and/or setting(s) for a feature. To be able to configure a device (e.g., device 300) correctly and/or to be able to determine if/whether a device is suitable for a feature to be enabled, an aggregator may be required to request a version, capability, and/or feature versions of the device. To do so, a controller of an aggregator device (e.g., 121, 221) may communicate with a controller of an endpoint device (e.g., 111-113, 211-215), whereby the aggregator controller may send a request for version information, the endpoint controller may send a response indicating version information, the aggregator controller may send a request for supported features, and the endpoint controller may send a response indicating supported features (e.g., such as described in further detail with respect to FIG. 6). If, however, the aggregator controller does not receive a response to these requests from the endpoint controller, the aggregator controller may (optionally) instruct its session manager (e.g., session manager 332) to communicate with a session manager of an endpoint device, for example, to determine whether the endpoint device supports any networked feature at all. In at least some examples, the aggregator controller may not instruct its session manager (e.g., session manager 332) to communicate with a session manager of an endpoint device. For example, an aggregator device may determine that a particular endpoint device may not (or does not) support networked DSP features (e.g., without communicating with a session manager). The aggregator session manager may send a request, to the endpoint session manager, for identification of capabilities of the endpoint device. The endpoint session manager may then send, to the aggregator session manager, an indication of one or more capabilities and/or channels (e.g., visible and/or hidden TX and/or RX channels) of the endpoint device. If the aggregator session manager does not receive a response indicating one or more capabilities of the endpoint device, the aggregator device may determine that the particular endpoint device does not support networked DSP features.

During the initialization process, each feature controller may register itself with the controller (e.g., controller 302). Registration may comprise a feature controller sending indications of a feature ID, an associated feature capability, a priority associated with the feature, a type of the feature (e.g., whether the feature is a main feature or a supplemental feature), and/or other properties associated with the feature. The controller may store the received indications in memory for later reference. For example, the controller may rely upon this information to manage interoperability between different features on the same device (e.g., for feature arbitration, priority, etc.), for feature advertisement to the rest of an audio system (e.g., 100, 200), and/or to manage interoperability between different devices in an audio system. Feature matrices may be used to indicate feature concurrency, interoperability, arbitration, and/or priority. For example, at least some features may be incompatible with other features such that they may not be enabled at the same time for a particular device. As another example, at least some features may have higher priority than other features, such that resources should be allocated to the higher priority features prior to allocating resources for lower priority features. As still another example, at least some features may have concurrency and/or priority specific to use in a device when used as an aggregator device and that may differ from concurrency and/or priority specific to use in the device when used as an endpoint device. As yet another example, each feature (for example, each DSP feature or other type of feature) may be expected to utilize a particular amount of device processing power, such as a particular percentage of total processing resources available at the device. Moreover, there may be efficiencies in shared processing power when two or more of the features are implemented concurrently. For example, implementing a first feature by a particular device may be expected to require 10% of that device's processing resources (e.g., cause there to be a 10% load on the device's processing resources), and a second feature may be expected to require 20% of that device's processing resources. Implementing the first feature and the second feature concurrently by that device may be simply a sum of the two processing loads (10% plus 20%, equaling 30% total processing load), or there may be realized efficiencies (for example, shared processes or memory storage) such that implementing the two features concurrently on the same device may only use 27% of the device's processing power. Any one or more of concurrency, capabilities, processing power utilizations, and/or priorities, for any one or more devices (e.g., endpoint devices and/or aggregator devices) may be stored in memory, such as in a table, matrix, and/or data set.

At step 520, the device may perform a feature enable and/or disable operation. An enable operation may comprise identifying one or more endpoint devices (e.g., 111-113, 211-215) to be used for a feature and enabling at least one aggregator device (e.g., 121, 221) and the identified endpoint device(s), so as to be able to perform networked DSP. A controller (e.g., controller 302) may enable or disable a particular networked DSP feature. The controller may inform a DSP (e.g., DSP 301) of its role for the networked DSP feature. For example, the controller may send a request to the DSP that indicates one or more of: a parameter type set, a device ID, a feature ID, and/or a feature enablement request. The DSP may validate the request. For example, the DSP may determine and/or indicate, for example, that the feature is not supported, that a role is not supported, that an aggregation link position is invalid, that request cannot be performed (e.g., that a request to disable a feature that is active, and/or that a request to enable a feature that is already enabled). After receiving a response from the DSP indicating that a feature has been enabled, the controller may create a channel link. The controller may indicate the channel link to the DSP.

At step 530, the device may perform aggregation link setup. A controller (e.g., controller 302) may request that a DSP (e.g., DSP 301) set up an aggregation link at a particular aggregation link position. An aggregation link may provide a real-time data link for communication of data in an audio system. An aggregation link may comprise a combination of routes (e.g., visible and/or invisible routes) that may be required to enable one or more networked DSP features. Aggregation links may be managed by an aggregator device (e.g., 121, 221). An aggregation link may be used to exchange time-critical data. Data communicated via an aggregation link may comprise audio and/or other data to be communicated via low latency from a device to one or more other devices. An aggregation link may use one or more protocols (e.g., Dante, AES67, RTP, etc.) for real-time DSP. For example, after one or more DSP features are enabled (e.g., at step 520), an aggregation link may be set up to allow for low-latency communications that may facilitate the control and/or operation of networked DSP. An aggregation link may be unidirectional or bidirectional. Aggregation link setup may comprise setting up a plurality of aggregation links. In at least some examples, one or more other links may be established that may be used to communicate non-time-critical information, such as via a non-time-critical protocol (e.g., ACN).

An aggregation link position may correspond to an index of a particular aggregation link (e.g., 0 to N−1, where N is the maximum number of endpoint devices supported by the aggregator). A DSP may have stored in memory feature-specific information as to what channels are required for a particular feature. Before setup, a feature must be enabled with at least one device (e.g., 300) having a role as an aggregator device (e.g., 121, 221). For example, an endpoint (e.g., 111-113, 211-215) may not be configured to set up an aggregation link. To set up an aggregation link, the controller may send a request to the DSP. The DSP may validate the request, for example, based on stored information about device(s). The DSP may send a response to the controller indicating, for example, whether a role as an aggregator device is supported for a particular device, and/or whether a channel is available. The controller and the DSP may communicate session management requests/responses for each channel (e.g., in parallel or in sequence). After all sessions have been created, the aggregation link may be established.

At step 540, the device may perform aggregation link teardown. Step 540 may be optional, for example, to update the links between devices of an audio system by removing links that are no longer needed (e.g., based on device turnoff/power down, device experiencing failure(s), feature deactivation for a device using a link, limitations reached or exceeded for a device, etc.). A controller (e.g., controller 302) may request that a DSP (e.g., DSP 301) teardown an aggregation link. Before teardown, a feature must be enabled with at least one device (e.g., 300) having a role as an aggregator device (e.g., 121, 221). For example, an endpoint (e.g., 111-113, 211-215) may not be configured to teardown an aggregation link. To teardown an aggregation link, the controller may send a request to the DSP. The DSP may validate the request, for example, based on stored information about device(s). The DSP may send a response to the controller indicating, for example, whether the aggregation link is found, and/or whether all sessions may be closed. The controller and the DSP may communicate session management requests/responses for each channel (e.g., in parallel or in sequence). After all sessions have been closed, the aggregation link may be torn down.

At step 550, the device may perform feature activation and/or deactivation. A feature may have a mode that is either active or inactive. A feature may be required to be enabled before it can be activated. Similarly, a feature may be required to be deactivated before it can be disabled. A controller (e.g., controller 302) may request that a DSP (e.g., DSP 301) activate or deactivate a feature. The DSP may validate the request, for example, based on stored information about device(s). The DSP may send a response to the controller indicating, for example, whether a feature is supported, whether an aggregation link position is valid, and whether a mode is invalid (e.g., if a request is to activate a feature that is not enabled, or if a request is to deactivate a feature that is inactive). After the DSP sends a response, the controller may perform the requested operation for the feature (e.g., activate the feature or deactivate the feature).

When configuring a networked feature, each device (e.g., device 300) may be identified by a device ID. The device ID may be determined by a controller (e.g., controller 302) and provided to a DSP (e.g., DSP 301). The DSP may use the feature to configure communications by a session manager (e.g., session manager 332) and to identify the device when communicating with the controller. Additionally or alternatively, a device may be identified by a link position (e.g., starting from 0). For example, a device ID may be a certain number or value, but when configuring a feature each device may also be identified by its link position. The link position may be used by the DSP to address other DSP over assigned channels. If a feature is enabled and/or activated, a controller may look up in a device list to identify a candidate device that is qualified for the feature. After a feature has been enabled in all qualified and enabled devices, the feature may be activated in each of those devices.

Any step, or portion of step, shown in FIG. 5 and/or described herein may be optional and/or may be performed in any order. For example, step 510 (e.g., initialization) may be performed, followed by a portion of step 520 (e.g., feature enablement), followed by step 530 (e.g., aggregation link setup), and followed by a portion of step 550 (e.g., feature activation). That is, feature disablement (e.g., a portion of step 520), aggregation link teardown (e.g., step 540), and/or feature deactivation (e.g., a portion of step 550) may not be performed and/or may be performed at a later time and/or out of sequence relative to other steps shown and described with respect to FIG. 5. After feature activation (e.g., a portion of step 550), the activated DSP feature may be performed. After feature deactivation (e.g., another portion of step 550), the deactivated DSP feature may not be performed, for example, at least until it may be re-enabled (e.g., such as by a portion of step 520 being performed) and/or re-activated (e.g., such as by a portion of step 550 being performed). In at least some examples, one or more steps of FIG. 5 may be performed for one DSP feature at a time (e.g., in series). In at least some other examples, one or more steps of FIG. 5 may be performed for a plurality of DSP features at a same time (e.g., in parallel).

FIG. 6 shows an example method for configuring networked DSP features. A method 600 may comprise a first component 621 communicating with one or more second components 611. The first component 621 and/or the second component 611 may be audio components. For example, the first component 621 and/or the second component 611 may comprise and/or may be included within one or more components of a device, such as of a device 300 described with respect to FIG. 3. For example, the first component 621 may comprise and/or may be included within the DSP 301. The second component 611 may comprise and/or may be included within the controller 302. As another example, the first component 621 and the second component 611 may comprise and/or be included within different devices, such as each component being one of two of device 300. For example, the first component 621 may comprise and/or may be included within an aggregator device (e.g., 121, 221). The aggregator device may correspond a first example of the device 300. The second component 611 may comprise and/or may be included within an endpoint device (e.g., 111-113, 211-215). The endpoint device may correspond to a second example of the device 300. The method 600 may comprise one or more operations of the methods 400, 401, and/or 500 described with respect to FIG. 4A, FIG. 4B, and/or FIG. 5, respectively.

Communications between the first component 621 and the second component 611 may comprise one or more requests and one or more corresponding responses. For example, the first component 621 may send to the second component 611 a request 601 that indicates information such as an ID, version, and/or capability of the first component 621 and/or that requests information such as an ID, version, and/or capability of the second component 611. The second component 611 may send to the first component 621 a response 602 that indicates an acknowledgement and/or information such as the ID, version, and/or capability of the second component 611. Based on the request 601 and/or the response 602, the first component 621 and/or the second component 611 may be initialized and/or configured to perform networked DSP generally in an audio system (e.g., 100, 200), although specific DSP features may not yet be enabled and/or activated by steps 601 and 602.

The first component 621 may send to the second component 611 a request 603. The request 603 may be sent, for example, after steps 601 and 602. The request 603 may indicate information such as DSP feature capability of the first component 621 and/or may request information such as DSP feature capability of the second component 611. The second component 611 may send to the first component 621 a response 604 that indicates an acknowledgement and/or information such as the DSP feature capability of the second component 611. Based on the request 603 and/or the response 604, the first component 621 and/or the second component 611 may be initialized and/or configured to perform specific DSP features (e.g., based on the DSP feature capability of the respective device(s)). As an example, specific DSP features may be enabled and/or activated in a manner as described with respect to step 520 and/or step 550 of FIG. 5. At step 605, the first component 621 and/or the component device 611 may perform one or more DSP features (e.g., based on the DSP feature capability of the respective device(s)).

One or more additional operations may be performed after steps 601-604 and before step 605. For example, steps 601-604 may be included in an initialization process, such as step 510 described with respect to FIG. 5, and any operation described with respect to steps 520, 530, 540, and/or 550 described with respect to FIG. 5 may be performed before step 605.

In at least some examples, the first component 621 may comprise an endpoint device (e.g., 111-113, 211-215), and the second component 611 may comprise an aggregator device (e.g., 121, 221). As another example, the first component may 621 comprise an aggregator device (e.g., 121, 221), and one or more second components 611 may comprise one or more endpoint devices (e.g., 111-113, 211-215). In such an example, the request 601 and/or the request 603 may comprise a message (e.g., advertisement message) sent to a plurality of endpoint devices. Also, in such an example, the response 602 and/or the response 604 may comprise a plurality of messages, wherein each message may be sent by a different endpoint device among a plurality of endpoint devices. As yet another example, the first component 621 may comprise the device 300 described with respect to FIG. 3, and the second component 611 may comprise another device 300. As still another example, the first component 621 may comprise one or more portions of the device 300 (such as DSP 301 and/or controller 302), and the second component 621 may comprise one or more other portions of the same device 300 (such as controller 302 and/or DSP 301).

As described above, step 550 may involve a controller causing a device to selectively enable or disable one or more features. The selection of which features to enable or disable (such as in step 412) may be determined based on a number of factors, for example, device capabilities, feature interoperabilities, feature processing utilizations, and/or the like, which may be indicated by, for example, one or more of the above-described feature matrices and/or via communications between devices of the audio system. The selection of which features to enable and/or disable may be performed to distribute (e.g., using load-balancing) the features amongst the various devices of the audio system. The distribution of features may take into account one or more factors (such as in the feature matrices). Moreover, which factors are considered for feature distribution may depend upon a particular feature distribution mode being implemented. For example, it may be desired that features be distributed so as to spread processing utilization across the devices, thereby avoiding any one device from having a processing utilization above a particular threshold processing utilization. As a further example, it may be desired that features be enabled and/or disabled so as to spread heat generation across the devices, thereby avoiding any one device from generating heat above a particular threshold heat generation parameter (e.g., device temperature). As a further example, it may be desired that features be enabled and/or disabled so as to spread processing utilization across the devices, by prioritizing one or more parameters (e.g., controlling processing utilization, heat, and/or the like to be within a particular range or below a particular threshold) for one or more identified devices of the audio system. As a further example, it may be desired that a particular one or more devices of the audio system be assigned features in a way that maintains heat produced by those one or more devices below a particular threshold. For example, those one or more devices may be in a room or other environment that cannot easily handle a large heat load. The type of feature distribution applied, and the parameters considered for determining a particular distribution of features, may depend on a particular feature distribution mode that may be indicated by a user.

A user, such as an end user or system integrator, may provide input to the audio system so as to manually configure which of the device(s) of the audio system performs which features. In other words, the user may manually select which features are to be enabled and/or disabled for each of the devices in an audio system. For example, the endpoint device 111 may be a microphone endpoint (e.g., the endpoint is or otherwise functions as a microphone) and the endpoint device 112 may be a loudspeaker endpoint (e.g., the endpoint is or otherwise functions as a loudspeaker). The user may manually configure the audio system 100 such that acoustic echo cancellation (AEC), noise reduction (NR), and voice activity detection (VAD) components are performed by the microphone endpoint 111 and/or the aggregator device 121, and parametric equalization (PEQ) is performed by the loudspeaker endpoint 112 and/or the aggregator device 121. Alternatively, configuration software may be used to automatically make the decisions. The decisions may be automatically made based on, for example, a pre-defined set of rules (which may be defined in the software). Whether this configuration is done manually or automatically by the user, the configuration may be a static configuration, or the configuration may dynamically change over time and/or as the audio system is reconfigured such as by adding or dropping endpoints and/or aggregators. The user input for manually selecting features may be provided via any of the devices of the audio system, such as an aggregator or an endpoint.

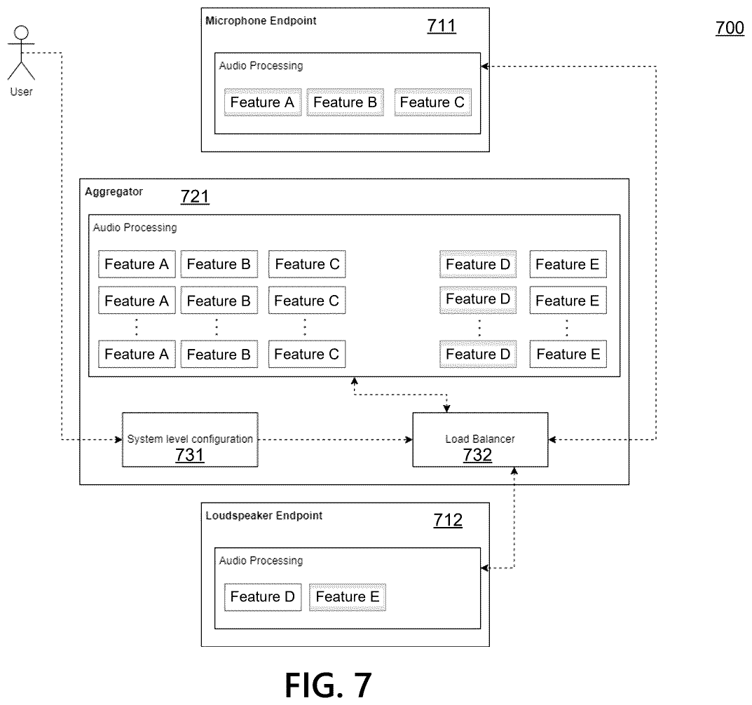

FIG. 7 shows a further example of an audio system 700 that includes a plurality of networked devices including, for example, an aggregator 721 and at least two endpoints 711 and 712. In this example, endpoint 711 may be a microphone endpoint, and endpoint 712 may a loudspeaker endpoint. A microphone endpoint may also include other functionality such as loudspeaker functionality, and a loudspeaker endpoint may also include other functionality such as microphone functionality. An endpoint may be, for example, any type of audio device such as a microphone, a loudspeaker, a mixer, a noise reducer, a digital signal processor, an audio recorder, and/or any combination thereof. In the example shown in FIG. 7, one or more of the devices of the audio system 700 may be capable of implementing various features, for example, Features A through E. A subset of the features may be selectively enabled and/or disabled for each of the devices. For example, the aggregator 721 may have the capability of performing all of Features A, B, and C yet be configured by the user to enable and implement only Feature D. Endpoint 711 may have the capability of performing both of Features A, B, and C, and be configured by the user to enable and implement all three of Features A, B, and C. Endpoint 712 may have the capability of performing both of Features D and E, yet be configured by the user to enable and implement only Feature E. Thus, amongst these devices in the audio system 700, each of Features A through E would be enabled and activated in at least one of the devices. Moreover, the selective enabling and/or disabling or various components may be performed on a channel-by-channel basis. For example, a first channel may be received by the aggregator 721 from microphone endpoint 711 and a second channel may be received by the aggregator from another microphone endpoint (not shown). The various features may be selectively enabled/disabled amongst the devices of the audio system 700 according to a first configuration to process audio of the first channel, and the various features may be selectively enabled/disabled amongst the devices of the audio system 700 according to a second configuration to process audio of the second channel, where the first and second configurations are different from each other. Enabling of a feature for a particular device (e.g., for a particular channel or for all channels) may cause the particular device to activate and perform the function associated with the feature (e.g., DSP processing such as for audio on the particular channel or for all channels). Disabling of a feature for a particular device (e.g., for a particular channel or for all channels) may prevent the particular device from performing functionality associated with that feature (e.g., for audio on that particular channel or for all channels).

In addition to or as an alternative to a user manually configuring the audio system, the audio system may be configured (by enabling/disabling features on various devices of the audio system) using software that may be stored in memory of one of the devices and that may be executed by one or more processors of that device. For example, the aggregator 721 or any of the endpoints 711, 712 may be a computing device (such as shown in FIG. 3) that executes such software and provides commands to the other devices in the audio system to selectively enable and/or disable one or more DSP components for one or more audio channels.

The aggregator 721 may include a system level configurator 731 and a load balancer 732. The system level configurator 731 and the load balancer 732 may be implemented by, for example, the controller 302 (FIG. 3). The system level configurator 731 may receive user input from the user. The user input may define a system level configuration. The system level configuration may identify a desired configuration of DSP features at a system level. For example, the system level configuration may indicate which one or more DSP features should be active (e.g., desired to be implemented in the audio system). The system level configuration may further identify one or more desired limitations to the distribution, which may be used by the aggregator 721 to determine the distribution of DSP features. For example, the system level configuration may identify a threshold processing usage not to be exceeded on one or more (or all) of the devices in the audio system. As a further example, the system level configuration may identify a maximum amount of heat generation by one or more (or all) of the devices in the audio system. As a further example, the system level configuration may identify a maximum amount of noise generation by one or more (or all) of the devices in the audio system. The system level configuration may additionally or alternatively include information such as feature prioritization rules, device prioritization rules, and/or an indication of a feature distribution mode. The load balancer 732 may receive the system level configuration, and as described above with respect to FIGS. 4A, 4B, 5, and 6, negotiate with the other devices in the audio system and cause each device of the audio system 700 to selectively enable/disable and activate/deactivate one or more features to implement the determined distribution of features. Thus, the user may only need to identify, at a high-level, which DSP features should be implemented, along with any desired limitations to how they are implemented, and the aggregator 721 can automatically determine the specific distribution of the DSP features consistent with any identified limitations. This may allow the audio system to handle the load-balancing behind-the-scenes without the user needing to worry about such details. The feature distribution may be performed once (e.g., may be static) or multiple times (e.g., may be dynamic). The feature distribution may be repeated each time a device is added to or removed from the audio system, or periodically.

Any given feature (for example, DSP feature) may have multiple sub-features or other portions thereof. For example, Feature A may have a plurality of sub-features. While FIG. 7 shows endpoint 711 as being configured to implement Feature A, in other examples endpoint 711 may be configured to implement one sub-feature (or other portion) of Feature A, and another device, such as another endpoint or aggregator 721, may be configured to implement another sub-feature (or other portions) of Feature A. The multiple portions of Feature A may operate on an audio signal in series (e.g., using pipeline processing) or in parallel. For example, a first sub-feature of Feature A may process an audio signal as implemented in a first device of the audio system, output the result of that processing as an input to a second sub-feature of Feature A as implemented in a second device of the audio system, and the second sub-feature may process that input to produce another audio signal output. Thus, a particular feature may be implemented by a single device of the audio system or distributed amongst a plurality of devices of the audio system.

The load balancer 732 may implement any of a number of different feature distribution modes. The feature distribution mode may be indicated by the system level configuration, or when not indicated the feature distribution mode may be a default feature distribution mode. An example of a feature distribution mode is a reduced power mode. The reduced power mode that may cause the load balancer 732 to distribute features across devices such that less power is drawn (for example, from a PoE switch). For example, the feature distribution may be performed so that no more than a particular total processing power, or wattage, or other measure of power, is utilized in each of the devices of the audio system or as a total amount of power utilized by the entire audio system. For example, it may be desired to set a threshold of 80% power utilization, in which in the reduced power mode the load balancer 732 would distribute features for implementation across devices such that no device has a processing utilization of more than the threshold (e.g., 80%) power utilization. This mode may be a compromise between audio processing resource load and consumed power. This mode may result in overall less audio processing resource load being available but may allow for more flexibility in installation of the devices.

Another example feature distribution mode that may be indicated by the system level configuration is a reduced fan speed mode. One or more of the devices of the audio system 700 may have a fan for mitigating thermal load on the device. However, such fans typically generate noise that may be undesirable where it is desired that the background audio is relatively quiet. The reduced fan speed mode may cause the load balancer 732 to configure one or more of the devices in the audio system in such as way as to reduce the thermal load on one or more of the devices so that the fan for those one or more devices is not needed as much or does not need to run on as high a speed as it otherwise might. For example, it may be desired to prevent one or more identified devices of the audio system from using enough processing power that the device's fan needs to be operated. For example, it may be desired that a particular one or more devices of the audio system be assigned features in a way that no more than a certain amount of heat is produced by those one or more devices so that the fan speeds of those one or more devices can be expected to remain below a particular threshold fan speed. For example, those one or more devices may be in a room or other environment that cannot easily handle a large heat load or where it is desired that background noise is kept at a minimum. The system level configuration may identify, for example, two devices that should only be enabled with features that would not require those devices to operate their fans to keep sufficiently cool. The determination of how features may be distributed, for implementation by various devices of the audio system, may be based in part on the expected power utilization of the various available features of those devices, and so the reduced fan speed mode may implement a relatively lower power threshold such as 30% power utilization on those identified devices, which may not need the fans to run on those devices. This mode may also be a compromise between audio processing resource load and background noise. This mode may also result in overall less audio processing resource load being available but may allow for more flexibility in installation of the devices, such being able to place certain audio devices closer to microphones.

The various devices in an audio system may be co-located in a single zone (e.g., within a single room or within a single portion of a room) or may be located in a plurality of different zones (e.g., a plurality of different rooms, different areas of the same room, or the like). In such a case, the feature distribution may additionally or alternatively take into account the zone of each device.

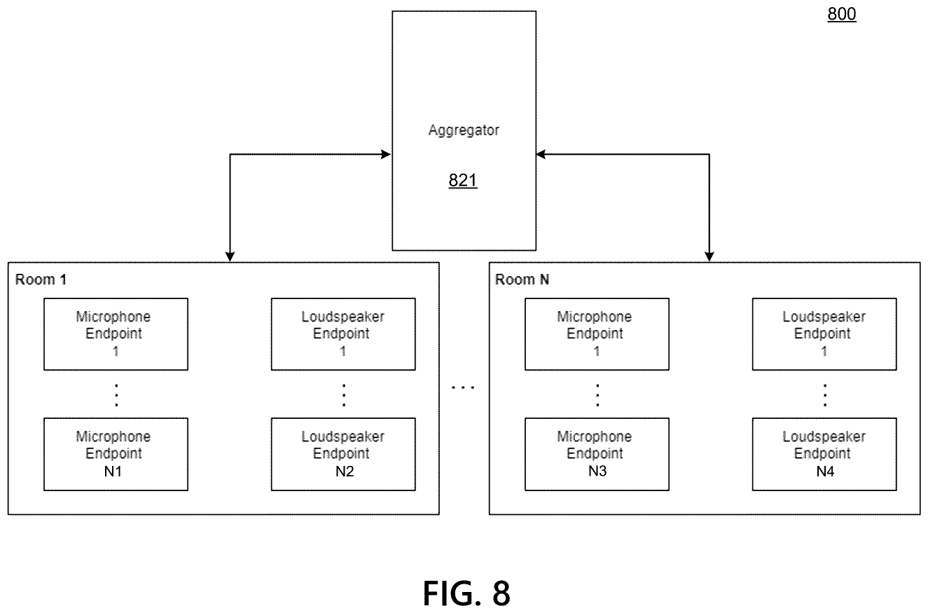

An example of how the networked devices in an audio system may be located in a plurality of different zones is shown in FIG. 8. In this figure, an aggregator 821 may be part of an audio system 800 and may be connected to a plurality of endpoints in a plurality of rooms or other zones. There may be N rooms or other zones, shown by way of example as Rooms 1 . . . N, where N is any positive integer. Room 1 may have N1 microphone endpoints and/or N2 loudspeaker endpoints, and Room N may have N3 microphone endpoints and N4 loudspeaker endpoints, where each of N1, N2, N3, and N4 is any positive integer or zero. While the aggregator 821 is not shown in a particular room, the aggregator 821 may be located in any of the Rooms 1 . . . N or outside the rooms. While each of the zones in FIG. 4 are shown as rooms, the zones may be rooms, sub-rooms, or any other physical areas as desired.

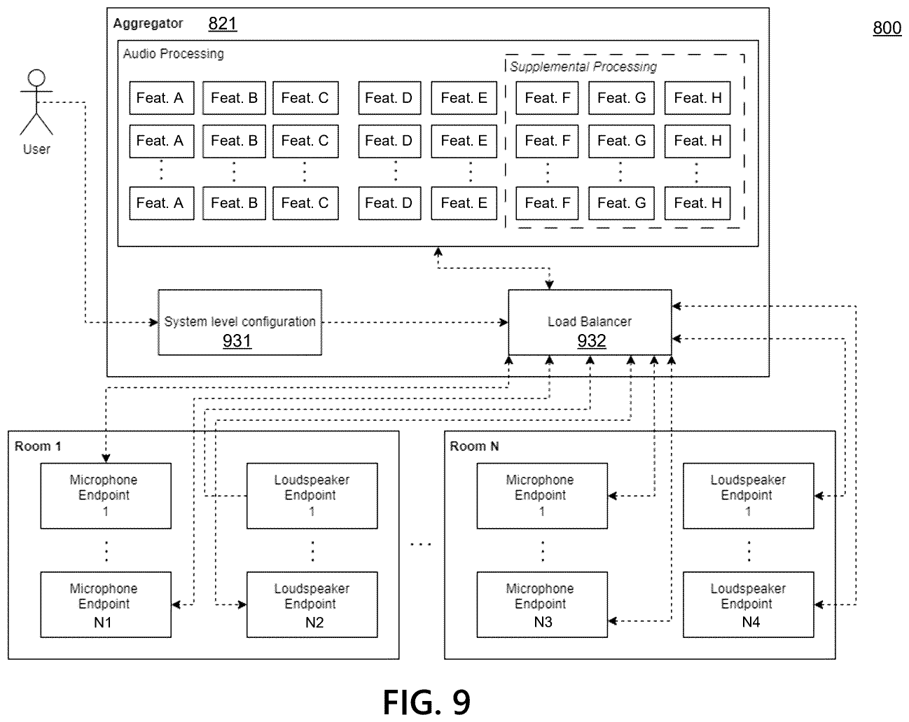

As shown in more detail in FIG. 9, the aggregator 821, like the aggregator 721, may have a system level configurator 931 and a load balancer 932. The system level configurator 931 may be the same as the system level configurator 731, and the load balancer 932 may be the same as the load balancer 732. The load balancer 932 may perform feature distribution across all of the devices of the audio system 800 and/or across a subset of the devices of the audio system 800 such as across the devices in Room 1. Moreover, feature distribution may be determined for each zone separately and/or in a different way, such as using a different feature distribution mode for each zone. For example, it may be desired that a first zone (e.g., Room 1) be distributed with features in accordance with a reduced power mode and a second zone (e.g., Room N) be distributed with features in accordance with a reduced fan speed mode. Moreover, device priorities and/or feature priorities may be defined across the entire audio system as well as within each zone. For example, a particular endpoint (e.g., microphone endpoint 1 of Room 1) may be assigned a first priority for the entire audio system and a second priority within a particular zone (e.g., Room 1) that contains the endpoint. Similarly, a particular feature (e.g., Feature A) may have a first priority for the entire audio system 800, a second priority within a first zone (e.g., Room 1), and/or a third priority within a second zone (e.g., Room N).

The aggregator 821 may have the capability of performing a plurality of features, such as Features A through H. Any of the other devices in the audio system 800, for example, any of the endpoints in any of the rooms, may also be capable of performing some or all of the plurality of features, and/or other features that the aggregator 821 is not capable of performing. The plurality of features (e.g., Features A through H) may be grouped into a plurality of groups. For example, a first group of features, of the plurality of features, may be considered to be main features that are expected to be more needed or considered to be of a higher priority. A second group of the features, of the plurality of features, may be considered supplemental features that may be optional, only needed on an occasional basis, or otherwise less important. The load balancer may perform feature distribution separately for each group of features. For example, the load balancer 932 may perform feature distribution for a first group (e.g., the main group) of features. Once the first group of features are assigned to various devices of the audio system 800, the load balancer 932 may perform feature distribution for one or more features of a second group (e.g., the supplemental feature group) using any device processing resources that may remain available in one or more devices after feature distribution is determined for the first group of features and/or the devices are configured to implement the assigned features. As a more specific example, the system level configuration may indicate that Features A through E are in a main group of features and/or that Features F, G, and H are in a second group of supplemental features. The load balancer 932 may perform feature distribution for one or more of Features A through E in the main group, enabling and/or disabling those features across some or all of the devices in the audio system 800. After that feature distribution is performed for the main group of features, the load balancer 932 may perform feature distribution for one or more of Features F through H in the supplemental group, enabling and/or disabling those features across some or all of the devices in the audio system 800.

Merely by way of example, main features may include mixing, filtering, equalization, noise reduction, acoustic echo cancellation, automatic gain control, delay, compression, and/or surround sound features. Merely by way of example, supplemental features may include artificial intelligence (AI) de-noiser, AI de-reverberation, and/or speech enhancement. However, any feature may be assigned to any group, as desired by the user and as defined by the user input to the system level configurator 931. Supplemental features, like main features, can be assigned on a per-channel basis (as shown in FIG. 9) or applied to an automixed output. Main features may be considered those features that the user (or some predefined rule) considers to be a minimum set of features that are needed or desired. By dividing the features into at least a main (e.g., needed) set of features and a supplemental (e.g., optional) set of features, the aggregator may be able to guarantee that the main feature set is implemented at a minimum. Any further supplemental/optional features may then be added to the features that are implemented by the audio system if processing headroom is available after implementing the main features.

Where at least some of the endpoints are located in different zones, feature distribution may be based on a zone status associated with each of one or more of the zones. For example, the load balancer 932 may take into account, for feature distribution, the status of a given zone - for example, whether the zone is active or inactive. A zone may be determined to be active if, for example, it is sensed or otherwise determined that a person is present in the zone, if voice activity is detected in the zone, and/or if an audio and/or video call is occurring in the zone using one of the audio system devices in the zone. A zone may be determined to be inactive if, for example, it is sensed or otherwise determined that a person is not present in the zone, if voice activity is not detected in the zone, and/or if an audio and/or video call is not occurring in the zone using one of the audio system devices in the zone. The audio system may include one or more sensors for detecting the presence of a person in one or more of the zones, such as an infrared sensor, a motion sensor, a microphone (e.g., one of the microphone endpoints of the audio system), or a camera. The audio system may include one or more sensors for detecting voice activity in a zone, such as a microphone (e.g., one of the microphone endpoints of the audio system). The audio system may determine whether a call is being made in a zone based on whether a call is in process using one or more of the endpoints in a zone. For example, if one of the endpoints in Room 1 is interfacing with a CODEC for a call, the fact that the CODEC is being used, or information provided by the CODEC, may be indicative of the call in progress.

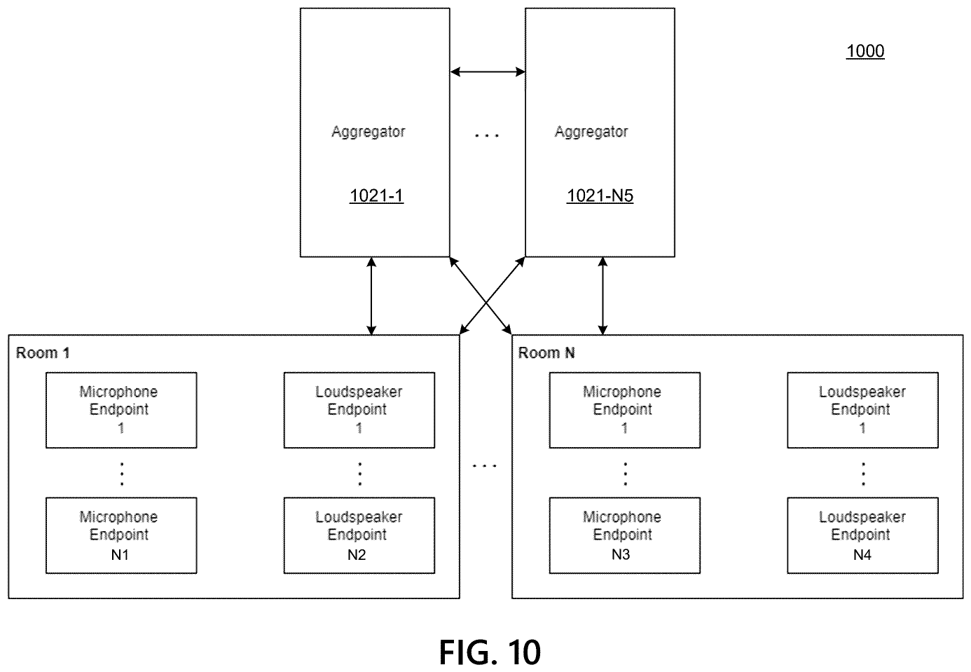

FIG. 10 shows a further example audio system 1000, which may be identical to the audio system 800 except that a plural quantity (N5) of aggregators 1021-1 through 1021-N5 (collectively referred to herein as aggregators 1021) may be used, where N5 may be any positive integer greater than one. The aggregators 1021 may be in communication with one another and/or with some or all of the other devices of the audio system 1000. Where there are a plurality of zones (for example, Rooms 1 through N as shown in FIG. 10), then there may be an aggregator responsible for load-balancing a respective zone. There may be more than one aggregator responsible for load-balancing a particular zone, and/or a particular aggregator may be responsible for load-balancing across multiple zones, such as across a particular subset of all of the zones. In general, X aggregators may be responsible for load-balancing within or across N zones (e.g., rooms),, where X may be equal to N, X may be greater than N, or X may be less than N. One of the aggregators may be designated as a lead aggregator. For example, the aggregator 1021-1 may be designated as the lead aggregator. The lead aggregator 1021-1 may be responsible for making the determination of which features are to be distributed to which devices of the audio system. In such a case, the lead aggregator 1021-1 may make the determination of how to distribute features and, based on the determined feature distribution, control one or more of the other aggregators 1021-2 through 1021-N5 to configure one or more of the devices of the audio system with one or more of the features. The lead aggregator 1021-1 may additionally or alternatively directly configure one or more of the devices of the audio system with one or more of the features based on the determined feature distribution. Regardless of whether one of the aggregators is designated as the lead aggregator, some or all of the feature distribution determination may be performed in a distributed manner by some or all of the aggregators 1021-1 through 1021-N5.

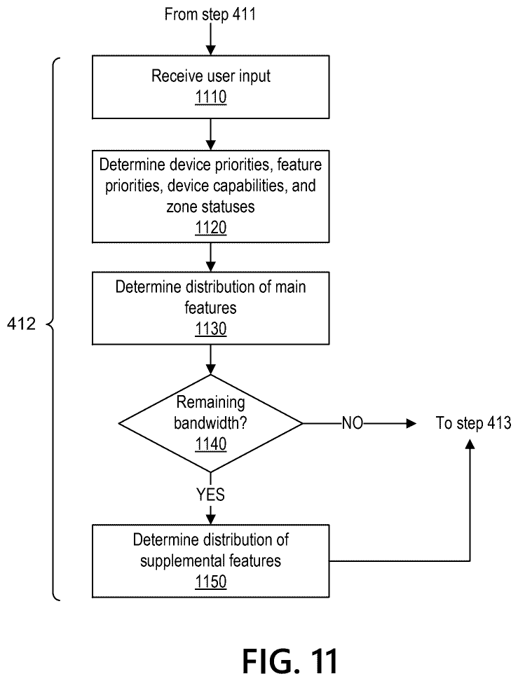

FIG. 11 is a flowchart showing an example implementation of step 412 of FIG. 4, in which step 412 may have sub-steps 1110 through 1150. As described above, in step 412, it may be determined how to distribute features across multiple devices of an audio system. One or more aggregators of the audio system, and in particular a system level configurator of one or more aggregators, may perform step 412. As shown in FIG. 11, step 412 may involve receiving a user input (sub-step 1110), such as the above-described system level configuration received by the system level configurator 731 or 931. At sub-step 1120, and based on the user input and/or other information such as stored data, various factors affecting feature distribution may be determined. For example, based on the user input and/or other information, one or more device priorities, feature priorities, device capabilities, and/or zone statuses may be determined.

The device priorities may indicate one or more priorities of one or more of the devices of the audio system. For example, referring to FIG. 9, microphone endpoint 1 of Room 1 may be assigned (e.g., by the user input) a first priority and microphone endpoint N1 of Room 1 may be assigned (e.g., by the user input) a second priority that is lower than the first priority. Device priorities may be taken into account when assigning features to devices. For example, if microphone endpoint 1 of Room 1 has a higher priority than microphone endpoint N1 of Room 1, then a given feature may be more likely to be assigned to microphone endpoint 1 as compared with microphone endpoint N1, particularly where there is insufficient processing power to assign the feature to both devices, or where there is a preference that would result in assigning the feature to only one of those devices.

The feature priorities may indicate one or more priorities of one or more features. For example, referring to FIG. 9, Features A may be assigned (e.g., by the user input) a first priority and Feature B may be assigned (e.g., by the user input) a second priority that is lower than the first priority. Feature priorities may be taken into account when assigning features to devices. For example, if Feature A has a higher priority than Feature B, then Feature A may be more likely to be assigned to a given device or to the audio system as compared with Feature B, particularly where there is insufficient processing power to assign both Feature A and Feature B, or where there is a preference that would result in assigning only one of the two features. Feature priorities may be in addition to grouping of features into groups such as main features and supplemental features. For example, features within the main features group may be prioritized relative to one another within the main features group, and features within the supplemental features group may be prioritized relative to one another within the supplemental features group. Moreover, the main features group as a whole may have a higher priority than the supplemental features group as a whole.

Device capabilities may indicate one or more capabilities of one or more devices of the audio system. Examples of device capabilities include an available processing resource of a device and/or which features a device is configured for and thus capable of implementing. For example, referring to FIG. 7, microphone endpoint 711 may have a first amount of available processing resource and is configured to be capable of implementing any of Feature A, Feature B, and Feature C, microphone endpoint 712 may have a second amount of available processing resource and is configured to be capable of implementing any of Feature D and Feature E, and aggregator 721 may have a third amount of available processing resource and is configured to be capable of implementing any of Feature A, Feature B, Feature C, Feature D, and Feature E. The device capabilities may be determined based on communications from the various devices to the aggregator, and/or based on the above-discussed feature matrices. Device capabilities may be taken into account when assigning features to devices. For example, since microphone endpoint 711 is not configured to implement Feature D, then Feature D would not be assigned to microphone endpoint 711. Rather, one or more features that microphone endpoint 711 is configured to implement (i.e., any one or more of Feature A, Feature B, or Feature C) may be assigned to microphone endpoint 711 for implementation.

Zone statuses may indicate the status of each of a plurality of zones of the audio system. For example, referring to FIG. 9, the zone referred to as Room 1 may have a first status, such as active, and the zone referred to as Room N may have a second status, such as inactive. Zone statuses may be taken into account when assigning features to devices. For example, the active/inactive state of a room may affect whether supplemental features are implemented, and if so, which room(s) supplemental features may be implemented in. For example, if Room 1 is determined to be inactive, then supplemental features associated with Room 2 may be enabled. If Room 1 becomes active (and therefore needs its own processing resources to implement features distributed to Room 1), then supplemental processing associated with Room 2 may be disabled or moved to be implemented by another room/zone that is currently inactive.

At sub-step 1130, it may be determined how to distribute one or more features for implementation by one or more devices of the audio system. The distribution of one or more features may be determined based on, for example, the factors determined at sub-step 1120 and/or user input received at sub-step 1110. As described previously, features that are categorized as “main” features may be prioritized over features that are categorized as “supplemental” features. Thus, sub-step 1130 may involve determining a distribution of, for example, only the main features. At sub-step 1140, the distribution of the main features may be modeled or otherwise analyzed to determine whether there is any remaining available processing resource in any of the devices in the audio system to implement additional features such as one or more of the supplemental features. The devices of the audio system may be sent control signals (such as in step 413) to enable and/or disable one or more main features in accordance with the distribution of the main features that was determined at sub-step 1130, and the devices may each communicate back an indication of their remaining available processing resource. For example, referring to FIG. 9, if microphone endpoint 1, of Room 1, is configured by the aggregator 821 to implement both of main Features A and C, then that microphone endpoint 1 may determine the amount of its processing resources that are used by implementing Features A and C, determine any remaining amount of processing resources that may be available for implementing one or more further features, and communicate that remaining processing resource amount to the aggregator 82. Alternatively, the aggregator 821 may track the amount of processing resources used by Features A and C and determine on its own whether there is any remaining processing resource available at that microphone endpoint 1. For example, implementing Features A and C may utilize 60% of the available processing resource of microphone endpoint 1 (e.g., require a 60% processing load), and so up to 40% of processing resources (out of a known maximum amount of potential processing resources for the device) may remain as available for implementing one or more further features, such as one or more of the supplemental features.

If it is determined at sub-step 1140 that there is not sufficient processing resource available to implement one or more supplemental features at a given device (e.g., at microphone endpoint 1 of Room 1), then the process of FIG. 11 may move to step 413 (following the “NO” path from sub-step 1140). On the other hand, if it is determined at sub-step 1140 that there is sufficient remaining processing resource available to implement at least one supplemental feature, then the process may move to sub-step 1150 (following the “YES” path from sub-step 1140), in which a distribution of one or more supplemental features may be determined that could be implemented using at least some of the remaining available processing resource of the device. The process may then move to step 413 to cause the devices to enable/disable the main features (and optionally any supplemental features) as determined in sub-step 1130 (and optionally in sub-step 1150). Sub-steps 1140 and 1150 may be performed for any one or more of the devices of the audio system, and may be performed on a device-by-device basis or for a plurality of the devices simultaneously.

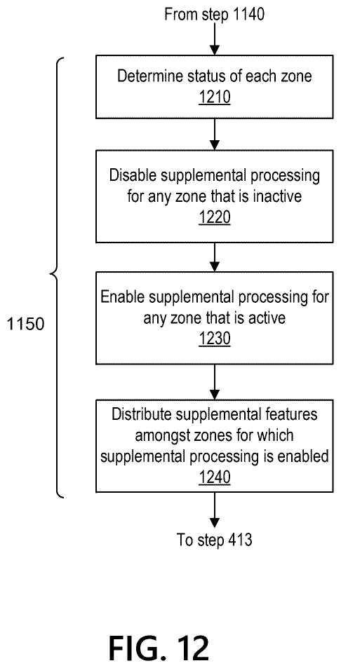

FIG. 12 is a flowchart showing an example implementation of step 1150 of FIG. 11, in which step 1150 may have sub-steps 1210 through 1240. In particular, step 1150 may determine the distribution of supplemental features, and in this example, the distribution of supplemental features to be implemented by a particular zone may be enabled or disabled based on the status of that zone. As explained previously, supplemental processing (e.g., the distribution of supplemental features for implementation) may be selectively done based on the availability of processing resources. Because processing resource availability may correlate with zone status, if a particular zone is inactive, it may be assumed that the processing resources of any devices in that zone are generally unused and available for supplemental processing. Likewise, if a zone is active, then the processing resources of any devices in that zone may not be considered available for supplemental processing. Moreover, because zones may change their status over time, it may be desirable to dynamically enable or disable supplemental processing in a particular zone over time based on the zone's change in status. For example, referring to FIG. 9, if Room 1 is determined to be inactive, then supplemental features associated with Room 2 may be enabled. If Room 1 becomes active (and therefore needs its own processing resources to implements features distributed to Room 1), then supplemental processing associated with Room 2 may be disabled or moved to be implemented by another room/zone that is currently inactive. At step 1210 of FIG. 12, an aggregator may determine the status of each zone in the audio system. At step 1120, the aggregator may disable supplemental processing for any zone that is determined to have an inactive status. At step 1230, the aggregator may enable supplemental processing for any zone that is determined to have an active status. At step 1240, the aggregator may distribute one or more supplemental features amongst one or more zones for which supplemental processing is enabled (e.g., zones that are active). Step 1150 (and/or the steps or processes of any of FIGS. 4A, 4B, 5, 6, 11, and/or 12 may be re-performed whenever the status of a zone is determined to have changed.

A first audio component may perform one or more operations. For example, the first audio component may send, to a second audio component, a request for digital signal processing (DSP) feature capability of the second audio component. The first audio component may receive (e.g., from the second audio component) a response indicating DSP feature capability of the second audio component. The first audio component may determine, based on the DSP feature capability of the second audio component and based on a DSP feature capability of the first audio component, one or more DSP features to perform. The first audio component may perform the one or more DSP features. The first audio component may perform the one or more DSP features by: receiving, from an audio component that is configured to perform a first portion of DSP associated with an audio signal, an output of the first portion of DSP; and/or performing, based on the output of the first portion of DSP, a second portion of DSP associated with the audio signal. The first portion of DSP may be associated with detection of the audio signal. The first portion of DSP may comprise at least one of: detection of the audio signal; detection of a location of the audio signal; noise reduction associated with the audio signal; acoustic echo cancellation associated with the audio signal; automatic gain control; and/or statistics derived from time-averaged audio signal level in specific frequency band (e.g., time-averaged audio signal level in one or more specific frequency bands). The second portion of DSP may be associated with an audio DSP procedure for the audio signal. Performing the second portion of DSP may comprise at least one of: mixing associated with the audio signal; filtering associated with the audio signal; and/or equalization associated with the audio signal; noise reduction associated with the audio signal; acoustic echo cancellation associated with the audio signal; and/or automatic gain control. The audio component that is configured to perform the second portion of DSP may be the second audio component. The first audio component may be a digital signal processor of an audio device. The second audio component may be a controller of the audio device. The audio device may be (or may be included in) one of: an aggregator device; or an endpoint device. The first audio component may be (or may be included in) an aggregator device configured to communicate with a plurality of endpoint devices that are each configured to perform at least a portion of DSP of the one or more DSP features. The second audio component may be (or may be included in) an endpoint device, of the plurality of endpoint devices, that is configured to perform a first portion of DSP of the one or more DSP features. A computing device may comprise the first audio component. The computing device may comprise: one or more processors; and memory storing instructions that, when executed, cause the computing device to perform one or more of the above operations. A system may comprise the first audio component and the second audio component. The system may comprise an aggregator device comprising the first audio component; and one or more endpoint devices comprising the second audio component (e.g., a plurality of endpoint devices, each of which comprise a second audio component). A non-transitory computer-readable medium may store instructions that, when executed, cause performance of one or more of the above operations.

A computing device may perform one or more operations. For example, the computing device may determine, based on available processing resources of a plurality of networked audio devices, a distribution of a first digital signal processing (DSP) feature to be performed by a first one or more audio devices of the plurality of networked audio devices. The computing device may configure the first one or more audio devices to perform the first DSP feature according to the distribution of the first DSP feature. The computing device may send, to the plurality of networked audio devices, one or more requests. The computing device may receive, in response to the one or more requests, one or more indications of the available processing resources. The computing device may determine, based on the available processing resources of the plurality of networked audio devices, a distribution of a second DSP feature to be performed by a second or more audio devices of the plurality of networked audio devices. The computing device may configure the second one or more audio devices to perform the second DSP feature according to the distribution of the second DSP feature. The computing device may receive, from the first one or more audio devices, a second audio signal resulting from performing the first DSP feature on a first audio signal, and may perform a second DSP feature on the second audio signal. The computing device may determine a remaining available processing resource of the first one or more audio devices that remains after the first one or more audio devices are configured to perform the first DSP feature. The computing device may determine, based on the remaining available processing resource, a second DSP feature, and configure the first one or more audio devices to perform the second DSP feature. The plurality of networked audio devices may be associated with a plurality of zones (e.g., rooms) comprising a first zone. In such a case, the computing device may configure the first zone, based on the first zone being in an active state, to implement a second DSP feature, and/or the computing device may disable the first zone, based on the first zone being in an inactive state, from implementing the second DSP feature. The computing device may determine the distribution of the first DSP feature further based on a plurality of processing loads of a plurality of DSP features. The computing device may determine the distribution of the first DSP feature further based on power consumptions of the plurality of networked audio devices. The computing device may determine the distribution of the first DSP feature further based on heat generation by the plurality of networked audio devices. The computing device may comprise, for example, an aggregator device, an audio device, and/or an endpoint device. The one or more audio devices may comprise, for example, an aggregator device, an audio device, and/or an endpoint device. The computing device and/or the one or more audio device may comprise at least one of a microphone or a speaker. The first DSP feature may be any DSP feature, for example a DSP feature that performs audio mixing, audio filtering, audio equalization, automatic gain control, acoustic echo cancellation, audio delay, audio noise reduction, or surround sound processing. The computing device may comprise one or more processors; and memory storing instructions that, when executed, cause the computing device to perform one or more of the above operations. A system may comprise the computing device and one or more networked audio devices of the plurality of networked audio devices. Computer-executable instructions may be stored on a non-transitory computer-readable medium (e.g., memory, hard disk, flash drive, and/or firmware) that, when executed, may cause a computing device to perform one or more of the above operations.

A computing device may perform one or more operations. For example, the computing device may determine, based on available processing resources of a plurality of networked audio devices, a distribution of a first digital signal processing (DSP) feature to be performed by a first one or more audio devices of the plurality of networked audio devices. The computing device may configure the first one or more audio devices to perform the first DSP feature according to the distribution of the first DSP feature. The computing device may send, to the plurality of networked audio devices, one or more requests. The computing device may receive one or more indications of the available processing resources, where the received one or more indications are in response to the one or more requests. The computing device may determine, based on the available processing resources of the plurality of networked audio devices, a distribution of a second DSP feature to be performed by a second or more audio devices of the plurality of networked audio devices. The computing device may configure the second one or more audio devices to perform the second DSP feature according to the distribution of the second DSP feature. The computing device may receive, from the first one or more audio devices, a second audio signal resulting from performing the first DSP feature on a first audio signal, and may perform a second DSP feature on the second audio signal. The computing device may determine a remaining available processing resource of the first one or more audio devices that remains after the first one or more audio devices are configured to perform the first DSP feature. The computing device may determine, based on the remaining available processing resource, a second DSP feature, and configure the first one or more audio devices to perform the second DSP feature. The plurality of networked audio devices may be associated with a plurality of zones (e.g., rooms) comprising a first zone. In such a case, the computing device may configure the first zone, based on the first zone being in an active state, to implement a second DSP feature, and/or the computing device may disable the first zone, based on the first zone being in an inactive state, from implementing the second DSP feature. The computing device may determine the distribution of the first DSP feature further based on a plurality of processing loads of a plurality of DSP features. The computing device may determine the distribution of the first DSP feature further based on power consumptions of the plurality of networked audio devices. The computing device may determine the distribution of the first DSP feature further based on heat generation by the plurality of networked audio devices. The computing device may comprise, for example, an aggregator device, an audio device, and/or an endpoint device. The one or more audio devices may comprise, for example, an aggregator device, an audio device, and/or an endpoint device. The computing device and/or the one or more audio device may comprise at least one of a microphone or a speaker. The first DSP feature may be any DSP feature, for example a DSP feature that performs audio mixing, audio filtering, audio equalization, automatic gain control, acoustic echo cancellation, audio delay, audio noise reduction, or surround sound processing. The computing device may comprise one or more processors; and memory storing instructions that, when executed, cause the computing device to perform one or more of the above operations. A system may comprise the computing device and one or more networked audio devices of the plurality of networked audio devices. Computer-executable instructions may be stored on a non-transitory computer-readable medium (e.g., memory, hard disk, flash drive, and/or firmware) that, when executed, may cause a computing device to perform one or more of the above operations.

Various examples herein describe an aggregator device (e.g., 121, 221) that may be used to flexibly control and/or communicate with one or more endpoint devices (e.g., 111-113, 211-215). Endpoint devices may be any audio devices which may comprise wired and/or wireless speakers, headphones, microphones, audio signal transceivers, and/or any other type of audio input and/or output device. The aggregator device may comprise one or more radio interfaces corresponding to any proprietary and/or non-proprietary wireless communication protocol. For example, the one or more radio interfaces may conform to Bluetooth protocol, Bluetooth protocol(s), Institution of Electrical and Electronics Engineers (IEEE) 802.11 Wi-Fi protocol(s), and/or any other wireless communication protocol. The aggregator device may additionally comprise one or more wired interfaces for communication with wired audio devices. The one or more wired interfaces may comprise one or more Ethernet interfaces, XLR interface(s), universal serial bus (USB) interface(s), 3.5 mm audio interface(s), and/or any other proprietary and/or non-proprietary wired interface(s).

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A computing device comprising:
one or more processors; and
memory storing instructions that, when executed by the one or more processors, cause the computing device to:
determine, based on available processing resources of a plurality of networked audio devices, a distribution of a first digital signal processing (DSP) feature to be performed by a first one or more audio devices of the plurality of networked audio devices; and
configure the first one or more audio devices to perform the first DSP feature according to the distribution of the first DSP feature.

2. The computing device of claim 1, wherein the instructions, when executed by the one or more processors, further cause the computing device to:
send, to the plurality of networked audio devices, one or more requests; and
receive, in response to the one or more requests, one or more indications of the available processing resources.

3. The computing device of claim 1, wherein the instructions, when executed by the one or more processors, further cause the computing device to:
determine, based on the available processing resources of the plurality of networked audio devices, a distribution of a second DSP feature to be performed by a second or more audio devices of the plurality of networked audio devices; and
configure the second one or more audio devices to perform the second DSP feature according to the distribution of the second DSP feature.

4. The computing device of claim 1, wherein the instructions, when executed by the one or more processors, further cause the computing device to:
receive, from the first one or more audio devices, a second audio signal resulting from performing the first DSP feature on a first audio signal; and
perform a second DSP feature on the second audio signal.

5. The computing device of claim 1, wherein the instructions, when executed by the one or more processors, further cause the computing device to:
determine a remaining available processing resource of the first one or more audio devices that remains after the first one or more audio devices are configured to perform the first DSP feature;
determine, based on the remaining available processing resource, a second DSP feature; and
configure the first one or more audio devices to perform the second DSP feature.

6. The computing device of claim 1, wherein the plurality of networked audio devices are associated with a plurality of zones, and wherein the instructions, when executed by the one or more processors, further cause the computing device to:
configure a first zone of the plurality of zones, based on the first zone being in an active state, to implement a second DSP feature; or
disable the first zone, based on the first zone being in an inactive state, from implementing the second DSP feature.

7. The computing device of claim 1, wherein the instructions, when executed by the one or more processors, further cause the computing device to:
determine the distribution of the first DSP feature further based on a plurality of processing loads of a plurality of DSP features.

8. The computing device of claim 1, wherein the instructions, when executed by the one or more processors, further cause the computing device to:
determine the distribution of the first DSP feature further based on power consumptions of the plurality of networked audio devices.

9. The computing device of claim 1, wherein the instructions, when executed by the one or more processors, further cause the computing device to:
determine the distribution of the first DSP feature further based on heat generation by the plurality of networked audio devices.

10. The computing device of claim 1, wherein the first DSP feature is one of:
audio mixing;
audio filtering;
audio equalization; or
automatic gain control.

11. The computing device of claim 1, wherein the first DSP feature is one of:
acoustic echo cancellation;
audio delay;
audio noise reduction; or
surround sound processing.

12. A non-transitory computer-readable medium storing instructions that, when executed, configure a computing device to:
determine, based on available processing resources of a plurality of networked audio devices, a distribution of a first digital signal processing (DSP) feature to be performed by a first one or more audio devices of the plurality of networked audio devices; and
configure the first one or more audio devices to perform the first DSP feature according to the distribution of the first DSP feature.

13. The non-transitory computer-readable medium of claim 12, wherein the instructions, when executed, further configure the computing device to:
send, to the plurality of networked audio devices, one or more requests; and
receive, in response to the one or more requests, one or more indications of the available processing resources.

14. The non-transitory computer-readable medium of claim 12, wherein the instructions, when executed, further configure the computing device to:
determine, based on the available processing resources of the plurality of networked audio devices, a distribution of a second DSP feature to be performed by a second or more audio devices of the plurality of networked audio devices; and
configure the second one or more audio devices to perform the second DSP feature according to the distribution of the second DSP feature.

15. The non-transitory computer-readable medium of claim 12, wherein the instructions, when executed, further configure the computing device to:
receive, from the first one or more audio devices, a second audio signal resulting from performing the first DSP feature on a first audio signal; and
perform a second DSP feature on the second audio signal.

16. The non-transitory computer-readable medium of claim 12, wherein the instructions, when executed, further configure the computing device to:
determine a remaining available processing resource of the first one or more audio devices that remains after the first one or more audio devices are configured to perform the first DSP feature;
determine, based on the remaining available processing resource, a second DSP feature; and
configure the first one or more audio devices to perform the second DSP feature.

17. The non-transitory computer-readable medium of claim 12, wherein the plurality of networked audio devices are associated with a plurality of zones, and wherein the instructions, when executed, further configure the computing device to:
configure a first zone of the plurality of zones, based on the first zone being in an active state, to implement a second DSP feature; or
disable the first zone, based on the first zone being in an inactive state, from implementing the second DSP feature.

18. The non-transitory computer-readable medium of claim 12, wherein the instructions, when executed, further configure the computing device to:
determine the distribution of the first DSP feature further based on a plurality of processing loads of a plurality of DSP features.

19. The non-transitory computer-readable medium of claim 12, wherein the instructions, when executed, further configure the computing device to:
determine the distribution of the first DSP feature further based on power consumptions of the plurality of networked audio devices.

20. The non-transitory computer-readable medium of claim 12, wherein the instructions, when executed, further configure the computing device to:
determine the distribution of the first DSP feature further based on heat generation by the plurality of networked audio devices.
